(19) United States
(12) Patent Application Publication
(10) Pub. No.: US 2020/0386039 A1
(43) Pub. Date: Dec. 10, 2020

(54) FLASHING FOR A BUILDING

(71) Applicant: Gabe Coscarella, Edmonton (CA)

(72) Inventor: Gabe Coscarella, Edmonton (CA)

(21) Appl. No.: 16/886,767

(22) Filed: May 28, 2020

Related U.S. Application Data
(60) Provisional application No. 62/853,589, filed on May 28, 2019.

(51) Int. Cl. E06B 1/62; E06B 1/70

(52) U.S. Cl. CPC E06B 1/62; E06B 1/70; E04D 13/15; E06B 2001/628; E06B 1/705

(57) ABSTRACT

A sill pan for a building opening has a bottom plate with a first end, a second end, a front edge and a rear edge. An end wall is located at the first end of the bottom plate and extends substantially away from the first end in a direction that is substantially perpendicular to the bottom plate. The end wall has a front edge and a rear edge that are coplanar to the front and rear edges of the bottom plate, respectively. A front skirt and a rear skirt are connected to the front and rear edges, respectively, of the bottom plate and the end wall. The bottom plate, end wall, front skirt, and rear skirt are vacuum formed as a unitary body from a foldable material. The bottom plate is self-supporting in a no-load condition and conformable to a load applied during installation in the building opening.

### TECHNICAL FIELD

This relates to flashing used to prevent water egress into a building, and in particular, to flashing for windows, doors, and other parts of a building.

### BACKGROUND

New constructions, such as residential homes, often require a building envelope that is weatherproof. The building envelope will have a variety of protrusions through the wall, such as doors and windows. It is often required to seal around these protrusions as part of the building envelope. United States Patent Application Publication No. 2014/0250801 (Knollmeyer) entitled “KIT AND COMPONENTS FOR A FLASHING INSTALLATION” teaches one method of sealing around a window to prevent water penetration by providing a set of components to surround the window opening.

### SUMMARY

According to an aspect, there is provided a sill pan for a building opening, comprising a bottom plate having a first end, a second end, a front edge, and a rear edge. An end wall is located at the first end of the bottom plate. The end wall extends substantially away from the first end in a direction that is substantially perpendicular to the bottom plate. The end wall has a front edge and a rear edge. The front edge of the end wall is coplanar with the front edge of the bottom plate and the rear edge of the end wall being coplanar with the rear edge of the bottom plate. A front skirt is connected to the front edge of the bottom plate and the front edge of the end wall. A rear skirt is connected to the rear edge of the bottom plate and the rear edge of the end wall. The bottom plate, the end wall, the front skirt and the rear skirt are vacuum-formed as a unitary body, the unitary body is made from a foldable material, and the bottom plate is self-supporting in a no-load condition and conformable under a applied during installation in the building opening.

According to other aspects, the sill pan may include one or more of the following features, alone or in combination: the bottom plate may comprise one or more protrusions that define at least a moisture-directing profile; the one or more protrusions may comprise crushable protrusions that at least partially undergo plastic deformation under the load applied during installation; the load may comprise a force applied between a bottom of a sill and a door or a window; there may be a second end wall at the second end of the bottom plate and the second end wall may extend substantially away from the second end in a direction that is substantially perpendicular to the bottom plate; the protrusions may extend along a width of the bottom plate, along a length of the bottom plate, or a combination of along the width and length of the bottom plate; the protrusions may further comprise shim protrusions that are collapsible when a sufficient load is applied; there may be a corner piece having first, second, and third orthogonal faces, the corner piece being sized and shaped to be overlapped by the front skirt adjacent to the first end of the end wall; there may be a side extension that is sized to overlap a portion of the front skirt and the rear skirt and overlap at least a portion of the end wall; in a no-load condition, the front skirt and the rear skirt may extend substantially parallel to the bottom plate and may be foldable relative to the bottom plate; and the rear edge of the bottom plate may be raised relative to the front edge.

According to an aspect, there is provided a method of waterproofing a bottom end of a building opening, the building opening being formed in a wall having a first face and a second face, the building opening being defined by a bottom surface, side surfaces, and a top surface, the method comprising the steps of:

providing a sill pan comprising a bottom plate having a first end, a second end, a front edge, and a rear edge; a first end wall located at the first end of the bottom plate, and a second end wall located at the second end of the bottom plate, the first end wall and the second end wall extending away from the bottom plate in a direction that is substantially perpendicular to the bottom plate, each of the first end wall and the second end wall having a front edge that is coplanar with the front edge of the bottom plate, and a rear edge that is coplanar with the rear edge of the bottom plate; a front skirt that is connected to the front edges of the bottom plate, the first end wall, and the second end wall; and a rear skirt that is connected to the rear edges of the bottom plate, the first end wall, and the second end wall; wherein the sill pan is vacuum-formed as a unitary body, the sill pan being self-supporting in a no-load condition;

positioning the sill pan in the building opening such that the bottom plate extends along the bottom surface of the building opening, the first end wall and the second end wall extend along a portion of the side surfaces, the front skirt extending parallel to the first face of the wall, and the rear skirt extending parallel to the second face; and

applying a load to the sill pan, the bottom plate of the sill pan conforming to the applied load.

According to other aspects, the method may include one or more of the following features, alone or in combination: the bottom plate may comprise protrusions that define at least a moisture-directing profile; the one or more protrusions may comprise crushable protrusions that at least partially undergo plastic deformation under the load applied to the sill pan; the bottom plate may comprise a first part and a second part that overlaps the first part; the method may further comprise the step of installing a window frame or a door frame such that the window frame or door frame applies a force to cause at least a portion of the protrusions to at least partially collapse toward the bottom plate; the protrusions may extend along a width of the bottom plate, along a length of the bottom plate, or a combination of along the width and length of the bottom plate; the method may further comprise the step of positioning a corner piece having first, second, and third orthogonal faces such that the corner piece is overlapped by the front skirt adjacent to the first end of the end wall; the method may further comprise the step of installing a side extension that is sized to overlap a portion of the front skirt and the rear skirt, and overlap at least a portion of the end wall; in a no-load condition, the front skirt and the rear skirt may extend substantially parallel to the bottom plate and further comprising the step of folding front skirt and the rear skirt when positioning the sill pan in the building opening; and the rear edge of the bottom plate may be raised relative to the front edge.

According to an aspect, there is provided a method of installing a sheet of waterproof material on a surface, the surface comprising first, second, and third faces, the first, second, and third faces being non-parallel and intersecting at edges, the edges intersecting at a vertex, the method comprising the steps of providing the sheet of waterproof material in a rest position, the sheet of waterproof material being foldable and comprising a planar web having a first inner edge, and a second inner edge facing the first inner edge, the first inner edge and the second inner edge meeting at a vertex within the planar web, and a connecting web connected between the first inner edge and the second inner edge, wherein the connecting web has a surface area that is greater than an area between the first inner edge and the second inner edge, and conforming the planar web and the connecting web to cover the first, second, and third faces of the surface.

According to other aspects, the planar web may comprise a first frame portion and a second frame portion, the first frame portion meeting the second frame portion at a fold line, and the sheet of material may be vacuum-formed.

According to an aspect, there is provided a sheet of waterproof material comprising a planar web having a first inner edge, and a second inner edge facing the first inner edge, the first inner edge and the second inner edge meeting at a vertex within the planar web, and a connecting web connected between the first inner edge and the second inner edge, wherein the connecting web has a surface area that is greater than an area between the first inner edge and the second inner edge, wherein the sheet of waterproof material is foldable and the planar web and connecting web are vacuum-formed into the sheet of material.

According to an aspect, there is provided a method of installing window flashing in a window opening of a wall, the method comprising the steps of providing window flashing in a rest position, the window flashing comprising a sheet of material that is foldable and substantially inelastic, the sheet of material comprising a frame section having a first frame portion and a second frame portion, the first frame portion meeting the second frame portion at a first fold line, a skirt section meeting the frame section at a second fold line that is perpendicular to the first fold line, the skirt section having a first skirt portion having a first inner edge, and a second skirt portion having a second inner edge facing the first inner edge, the first inner edge and the second inner edge meeting at a vertex of the first fold line and the second fold line, and a connecting web connected between the first inner edge and the second inner edge, wherein the frame section and the first and section portions of the skirt section define a plane, and the connecting web extends outward from the plane, folding the sheet of material along the first fold line and the second fold line to conform to a corner of the window opening such that the first frame portion is angled relative to the second frame portion and the skirt portion extends away from the frame section, the connecting web maintaining an uninterrupted surface between the first and second inner edges as the sheet of material is folded, and placing the window flashing into the window opening such that the frame portion overlies at least a portion of an inner surface of the frame, and such that the skirt portion and the connecting web overlies at least a portion of a front face of the frame.

According to other aspects, folding the sheet of material to conform to a corner of the window opening may not place the connecting web under tension, folding the sheet of material along the second fold line may comprise folding the skirt section to cover an exterior portion of the wall, the sheet of material may further comprise a rear skirt section that meets the frame section at a third fold line that is parallel to the second fold line, the method may further comprise the step of folding the sheet of material along the third fold line to cover an interior portion of the wall, the sheet of material may comprise a recess along at least a portion of the length of the second fold line, the frame section may comprise a back dam, the back dam defining a self-supporting portion of the sheet of material that extends out of the plane, the frame section may comprise a raised portion that slopes downwards towards the second fold line, the sheet of material may be vacuum formed, the method may further comprise the step of securing the window flashing to the window opening, and the method may further comprise the steps of placing a second window flashing into the window opening, overlapping at least a portion of the window flashing and the second window flashing, and folding the second window flashing to conform to a second corner of the window opening.

According to an aspect, there is provided window flashing, comprising a sheet of material that is foldable and substantially inelastic, the sheet of material comprising a frame section having a first frame portion and a second frame portion, the first frame portion meeting the second frame portion at a first fold line, a skirt section meeting the frame section at a second fold line that is perpendicular to the first fold line, the skirt section having a first skirt portion having a first inner edge, and a second skirt portion having a second inner edge facing the first inner edge, the first inner edge and the second inner edge meeting at a vertex of the first fold line and the second fold line, and a connecting web connected between the first inner edge and the second inner edge, wherein, in a rest position, the frame section and the first and section portions of the skirt section define a plane, and the connecting web extends outward from the plane, and wherein, in a use position, the sheet of material is folded along the first fold line and the second fold line to conform to a corner of a window such that the first frame portion is angled relative to the second frame portion and the skirt portion extends away from the frame section, the connecting web maintaining an uninterrupted surface between the first and second inner edges as the sheet of material is folded.

According to other aspects, in the use position, the connecting web may not be under tension, the sheet of material may further comprise a rear skirt section that meets the frame section at a third fold line that is parallel to the second fold line, and the sheet of material may comprise a recess along at least a portion of the length of the second fold line, the frame section may comprise a back dam, the back dam may define a self-supporting portion of the sheet of material that extends out of the plane, the frame section may comprise a raised portion that slopes downwards towards the second fold line, and the sheet of material may be vacuum-formed.

According to an aspect, there is provided window flashing, comprising a sheet of material that is foldable and substantially inelastic, the sheet of material comprising a frame section having a first frame portion and a second frame portion, the first frame portion meeting the second frame portion at a first fold line, a skirt section meeting the frame section at a second fold line that is perpendicular to the first fold line, a first inner edge and a second inner edge that extend from a vertex of the first fold line and the second fold line to an outer perimeter of the sheet of material, at least the first inner edge being adjacent to the skirt section, and a connecting web connected between the first inner edge and the second inner edge, wherein, in a rest position, the frame section and the first and section portions of the skirt section define a plane, and the connecting web extends outward from the plane, and wherein, in a use position, the sheet of material is folded along the first fold line and the second fold line to conform to a corner of a window such that the first frame portion is angled relative to the second frame portion and such that the skirt portion and the connecting web extend away from the frame section, the connecting web maintaining an uninterrupted surface between the first and second inner edges as the sheet of material is folded.

According to an aspect, there is provided a method of installing window flashing in a window opening of a wall, the method comprising the steps of providing window flashing in a rest position, the window flashing comprising a sheet of material that is foldable and substantially inelastic, the sheet of material comprising a frame section having a first frame portion and a second frame portion, the first frame portion meeting the second frame portion at a first fold line, a skirt section meeting the frame section at a second fold line that is perpendicular to the first fold line, the skirt section having a first skirt portion having a first inner edge, and a second skirt portion having a second inner edge facing the first inner edge, the first inner edge and the second inner edge meeting at a vertex of the first fold line and the second fold line, and a connecting web connected between the first inner edge and the second inner edge, wherein the frame section and the first and section portions of the skirt section define a plane, and the connecting web extends outward from the plane, the skirt section having a first skirt portion having a first inner edge, and a second skirt portion having a second inner edge facing the first inner edge, the first inner edge and the second inner edge meeting at a vertex of the first fold line and the second fold line, folding the sheet of material along the first fold line and the second fold line to conform to a corner of the window opening such that the first frame portion is angled relative to the second frame portion and the skirt portion extends away from the frame section, the connecting web maintaining an uninterrupted surface between the first and second inner edges as the sheet of material is folded, and placing the window flashing into the window opening such that the frame portion overlies at least a portion of an inner surface of the frame, and such that the skirt portion and the connecting web overlies at least a portion of a front face of the frame.

According to an aspect, there is provided a sheet of waterproof material comprising a planar web having a first inner edge, and a second inner edge that extends at an angle from the first inner edge, the first inner edge and the second inner edge meeting at a vertex within the planar web, and a connecting web connected between the first inner edge and the second inner edge, wherein the connecting web has a surface area that is greater than an area between the first inner edge and the second inner edge, wherein the planar web and the connecting web are made from a foldable material, and the planar web has a fold line that extends from the vertex, such that folding the planar web along the fold line causes the planar web and the connecting web to conform to a window sill of a building.

According to another aspect, the planar web may comprise a third inner edge that extends at an angle from the second inner edge, the third inner edge and the second inner edge meeting at a second vertex within the planar web that is spaced from the vertex, the connecting web being connected to the first inner edge, the second inner edge, and the third inner edge, and the planar web has a second fold line that extends from the second vertex, the second fold line being parallel to the fold line such that folding the planar web along the fold line and the second fold line causes the planar web and the connecting web to conform to opposed sides of the window sill of the building.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view in cross-section of a window having a back dam and window flashing.

FIG. 2 is a perspective view of window flashing installed on the corner of a window frame in a first configuration.

FIG. 3 is a perspective view of window flashing installed on the corner of a window frame in a second configuration.

FIG. 4 is a perspective view of window flashing installed on the corner of a window frame in a third configuration.

FIG. 5 is a perspective view of window flashing installed on the corner of a window frame and connected to a second piece of window flashing.

FIG. 6 is a perspective view of window flashing installed on a corner of a window frame and having a drainage path defined by a raised barrier.

FIG. 7 is a perspective view of window flashing that extends around the window frame and has a central moisture barrier.

FIG. 8 is a perspective view of window flashing with a single corner at rest prior to installation.

FIG. 9 is a perspective view of window flashing with a single corner at rest prior to installation.

FIG. 10 is a perspective view of window flashing with a single corner, a back dam, and a defined fold region.

FIG. 11 is a perspective view of window flashing with a single corner and a back dam with sloped surfaces.

FIG. 12 is a perspective view of window flashing with a single corner and a drainage path defined by a back dam, sloped surface, and drainage channel.

FIG. 13 is a perspective view of window flashing with a single corner, a partial back dam, and multiple drainage channels.

FIG. 14 is a perspective view of window flashing with a single corner and a front dam.

FIG. 15 is a perspective view of window flashing with a single corner that is rounded.

FIG. 16 is a perspective view of window flashing with two corners, a back dam, and a defined fold area.

FIG. 17 is a perspective view of window flashing with two corners, a partial back dam, and a sloped surface.

FIG. 18 is a perspective view of window flashing with a drainage profile and a single upwardly folded corner.

FIG. 19 is a perspective view of window flashing with a drainage profile and a single downwardly folded corner.

FIG. 20 is a perspective view of window flashing having a defined fold area and a back dam.

FIG. 21 is a perspective view of window flashing having a raised back dam and a sloped surface.

FIG. 22 is a perspective view of window flashing having two corners.

FIG. 23 is a perspective view of two sections of window flashing having single corners overlapped to provide two corners.

FIG. 24 is a perspective view of two sections of window flashing having single corners and back dams overlapped to provide two corners and a continuous back dam.

FIG. 25 is a perspective view of window flashing having two corners, a back dam, and drainage channels.

FIG. 26 is a perspective view of window flashing having two corners, drainage elements, and a sloped surface.

FIG. 27 is a perspective view of window flashing having four corners.

FIG. 28 is a perspective view of two sections of window flashing having two corners overlapped to provide four corners.

FIG. 29 is a perspective view of two sections of window flashing having two corners overlapped to provide four corners and having drainage elements in the overlap area.

FIG. 30 is a perspective view of window flashing having four corners, a front dam, and drainage elements.

FIG. 31 is a side elevation view in cross section of a window having flashing with a back dam.

FIG. 32 is a side elevation view in cross section of a window having flashing with a central dam.

FIG. 33 is a side elevation view in cross section of a window having flashing with a front dam.

FIG. 34 is a detailed side elevation view in cross section of a window with window flashing and window shim.

FIG. 35 is a perspective view of flashing having an interiorly folded corner.

FIG. 36 is a perspective view of flashing having an exteriorly folded corner.

FIG. 37 is a perspective view of flashing installed at the corner of a roof.

FIG. 38 is a perspective view of roof flashing.

FIG. 39 is a perspective view of the top of a window shim.

FIG. 40 is a perspective view of the bottom of a window shim.

FIG. 41 is a perspective view of an alternative embodiment of a window shim.

FIG. 42 is a perspective view of a second embodiment of a window shim.

FIG. 43 is a perspective view of a window flashing with a textured surface.

FIG. 44 is a perspective view of a window flashing with a skirt portion that may be folded along a fold line.

FIG. 44a is a perspective view of a window flashing formed to sit in a corner of a rough opening of a building.

FIG. 45 is a perspective view of a window flashing with front and rear skirt portions that are folded down.

FIG. 46 is a perspective view of an installed window flashing with front skirt portion folded down.

FIG. 47 is a perspective view of a window flashing with a side extension.

FIG. 48 is a perspective view of a window flashing with one secondary sheet of material.

FIG. 49 is a perspective view of a window flashing with two secondary sheets of material.

FIG. 50 is a perspective view of a single-ended sill pan.

FIG. 51 is a perspective view of a double-ended sill pan.

FIG. 52 is a perspective view of an overlapping sill pan.

FIG. 53 is a side elevation view in section of a sill pan in a rough opening of a building.

FIG. 54 is a side elevation view in section of a sill pan installed below a door.

FIG. 55 is a side elevation view in section of a sill pan installed below a window.

FIG. 56 is a side elevation view in section of a sill pan installed below a door and connected to flooring.

### DETAILED DESCRIPTION OF PREFERRED EMBODIMENTS

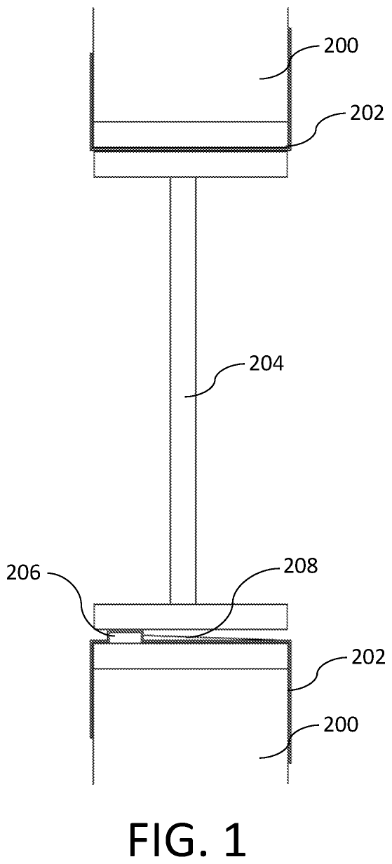

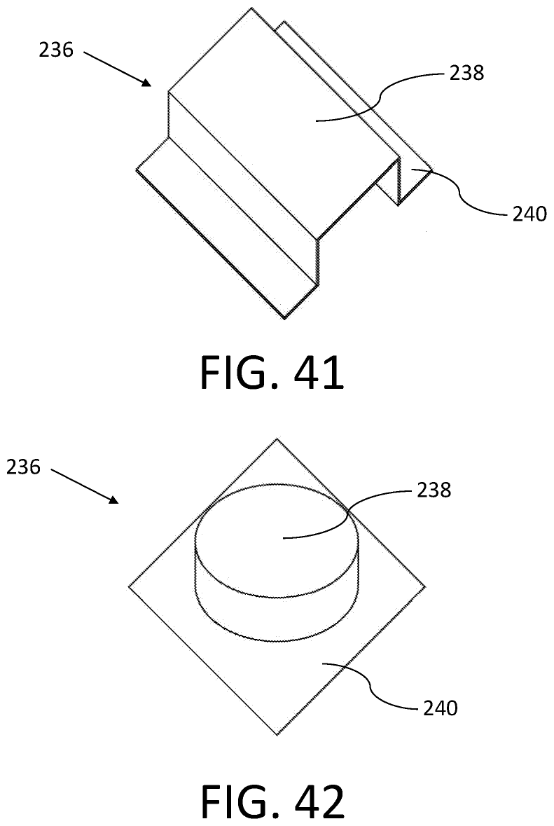

A flashing for protecting openings in building, such as windows and doors, or protect joints of material, such as flashing on roofs, etc., is generally identified by reference numeral 100 and will be described with reference to FIG. 1 through 56. Flashing 100 may be used as a sill pan for windows or doors, and is preferably made from a flexible substrate that facilitates transport, storage, and installation, while maintaining sufficient structure to easily conform to the opening in which it is installed. It will be understood that, while the device is referred to below as flashing, it is primarily a sheet of flexible, waterproof material that is intended to be installed within an opening in a structure to protect against water penetration, such as on the inside of an opening in which a window or door is installed. Flashing 100 may also be referred to as a sill pan, or may be used in combination with other elements, as will be understood from the discussion below, to properly protect the opening from water penetrations or to be designed to cooperate with other elements, such as a sill, jamb, etc. Flashing 100 may also be designed to protect joints of a roof or other parts of a building, as will be understood from the discussion below.

As will be understood from the discussion below, flashing 100 may be folded in a variety of ways to facilitate installation, and according to the preferences of the user. Flashing 100 is preferably vacuum formed from a suitable material in order to allow for a desired degree of flexibility and conformability. In particular, flashing 100 is preferably made from a material sufficiently flexible to be bendable, meaning that it may be doubled over onto itself without incurring any damage or substantial plastic deformation, although some suitable materials may be creased if sufficient pressure is applied along the fold line. As flashing 100 is made from foldable and bendable materials, it may be folded for transport, storage, and also manipulated during installation to conform to the surface on which it is installed. As discussed below, the corners of flashing 100 may be folded in such a way that flashing 100 lays mostly flat, but unfolds into a corner piece. Alternatively, flashing 100 may be L-shaped with one portion being a flat surface, and the other portion having a U-shaped cross section. During installation, the front and/or rear portions of the flat surface are intended to be folded down to surround a rough opening in a building window or door frame. Flashing 100 may also be formed in the desired shape, with an appropriately shaped cross-section that is intended to engage the appropriate surface. In addition, because flashing 100 is flexible, it is able to conform to a surface that may not be at a right angle (or other intended angle), or conform to a dimension that is slightly larger or smaller than expected, or conform to a surface imperfection, such as a raised portion, without being damaged or requiring other remedial work. These and other features will be apparent from the discussion below.

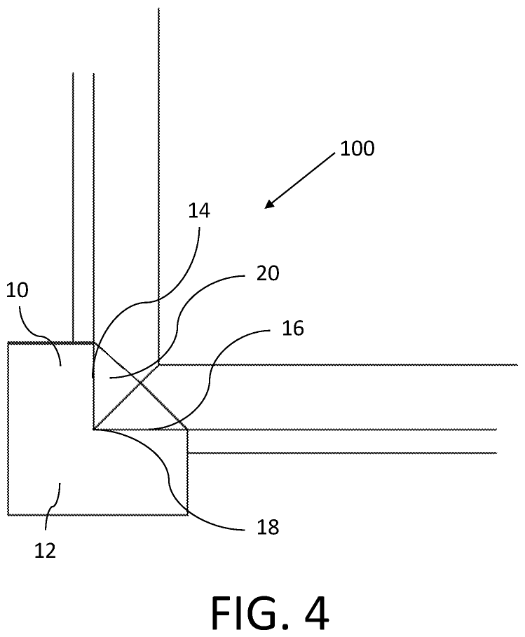

Referring to FIG. 4, an example of a flashing 100 made from a sheet of waterproof material 10 is provided that has a planar web 12 with a first inner edge 14 and a second inner edge 16 that faces first inner edge 14. First inner edge 14 and second inner edge 16 meet at a vertex 18 within planar web 12. In this example, a connecting web 20 is connected between first inner edge 14 and second inner edge 16, and connecting web 20 has a surface area that is greater than an area between first inner edge 14 and second inner edge 16. Sheet of waterproof material 10 is foldable. Planar web 12 and connecting web 20 may be vacuum-formed into sheet of material 10.

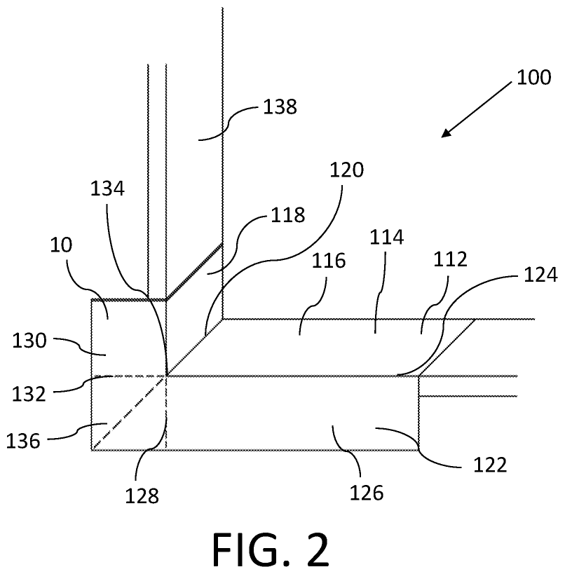

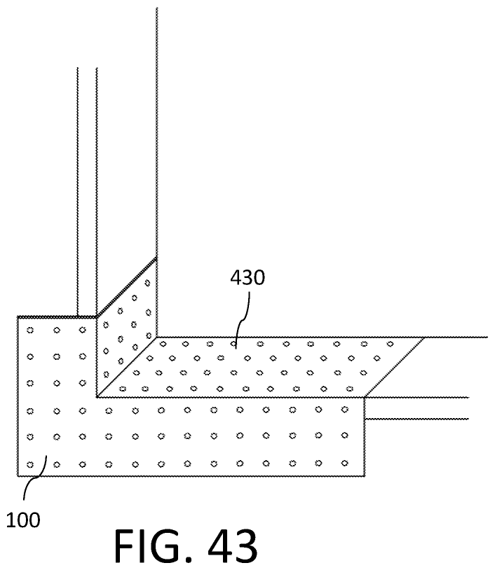

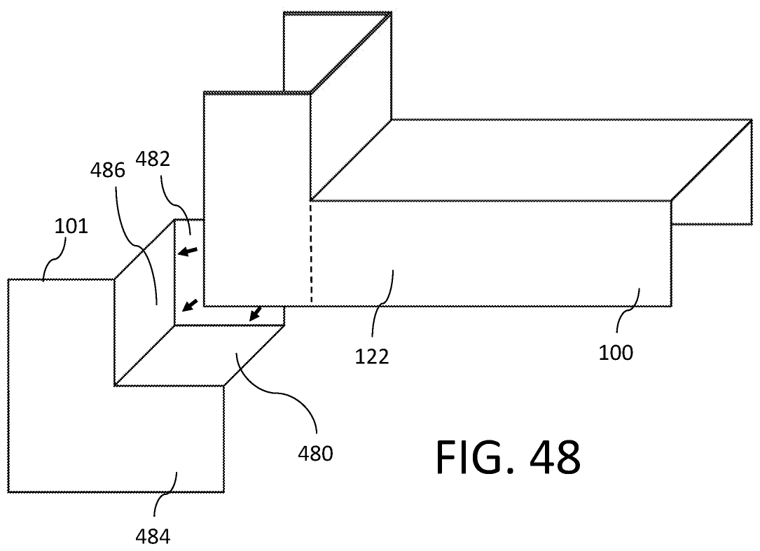

Flashing 100 may be used in a variety of applications where it is desired to form a waterproof barrier over a surface or between two surfaces. For example, referring to FIG. 1, flashing 100 may be used to form a waterproof (or water resistant) barrier within a window frame, door frame, or as part of roof flashing or other building flashing, particularly where it is desired to cover a corner or another point with non-parallel surfaces. Flashing 100 may also be used in situations where it is desired to form a waterproof barrier around a shape, such as in the case of shower pans or other plumbing fixtures. Flashing 100 may take a variety of forms. In some examples, such as those depicted in FIGS. 2-30, sheet 10 is made from a foldable material and is formed in such a way that an expandable connecting web is provided adjacent to a corner, such that flashing 100 is relatively flat in a rest position, and may otherwise be collapsible. This may be useful to flatten sheet 10 such that they are able to be stacked for storage or transport. In other examples, flashing 100 may be formed and maintained in substantially the form or shape they are intended to be used, such as is shown in FIGS. 43 and 48.

In general, the various examples of flashing described herein are made from sheets of material that are foldable sufficiently to be manipulated easily by hand such that an installer may position them on a surface without difficulty or additional tools, while being sufficiently resilient to maintain its shape at rest, such as with no external loads or forces being applied. Preferably, the shape at rest will be the shape in which the sheet is vacuum formed. The material may be a suitable plastic, such as polyethylene, that is sufficiently thin to be foldable, while sufficiently thick to maintain its general shape at rest when properly supported. The general shape referred to herein refers primarily to the fold lines that are formed during manufacturing, and while the material may bend under its own weight, depending on how it is being supported, the fold lines will be maintained. Folding may include both alterations to the shape at intended locations to create a particular shape, or folds that are a result of loads placed on the sheet, which may crush or collapse portions of the sheet without compromising the waterproofing capabilities of the sheet. The various shapes described herein are preferably vacuum formed to allow for thinner material to be used when compared to processes such as injection molding or extrusion.

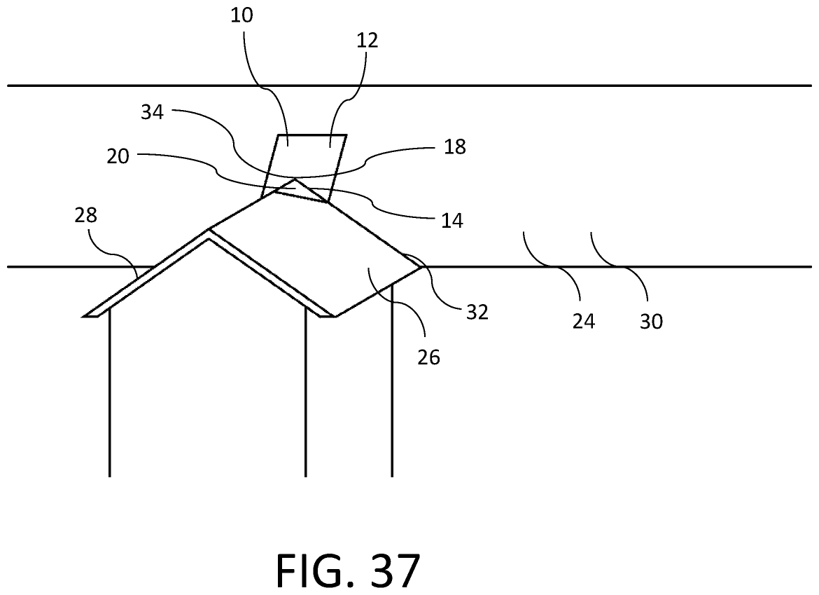

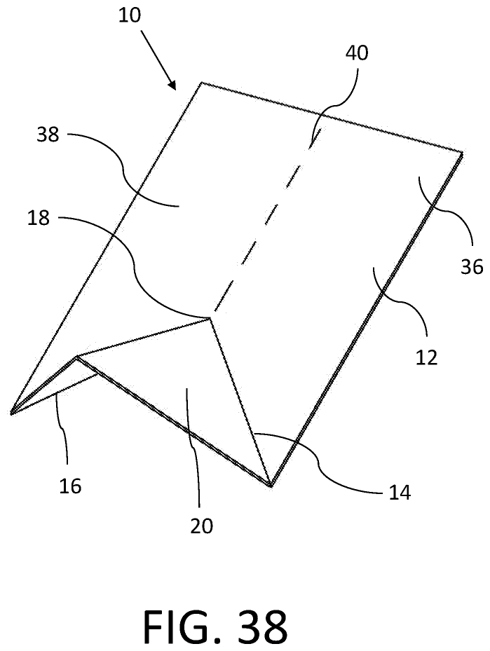

A method of installing an example of flashing 100 will now be described with reference to FIG. 37, which depicts a roof as surface 24. It will be understood that the method described may be used to apply sheet of waterproof material 10 to any surface 24 that has a first face 26, a second face 28, and a third face 30, all of which are non-parallel and intersect at edges 32, with edges 32 intersecting at a vertex 34. The method has the steps of providing sheet of waterproof material 10 in a rest position, and then conforming planar web 12 and connecting web 20 to cover the first, second, and third faces 26, 28, and 30 of surface 24. When surface 24 is a window or door frame, or another type of opening with a frame, planar web 12 may have a first frame portion 36 and a second frame portion 38, first frame portion 36 meeting second frame portion 38 at a fold line 40, as shown in FIG. 38. Sheet of material 10 is preferably vacuum-formed to create the shape shown in FIG. 38, as well as other shapes shown in the drawings and described herein.

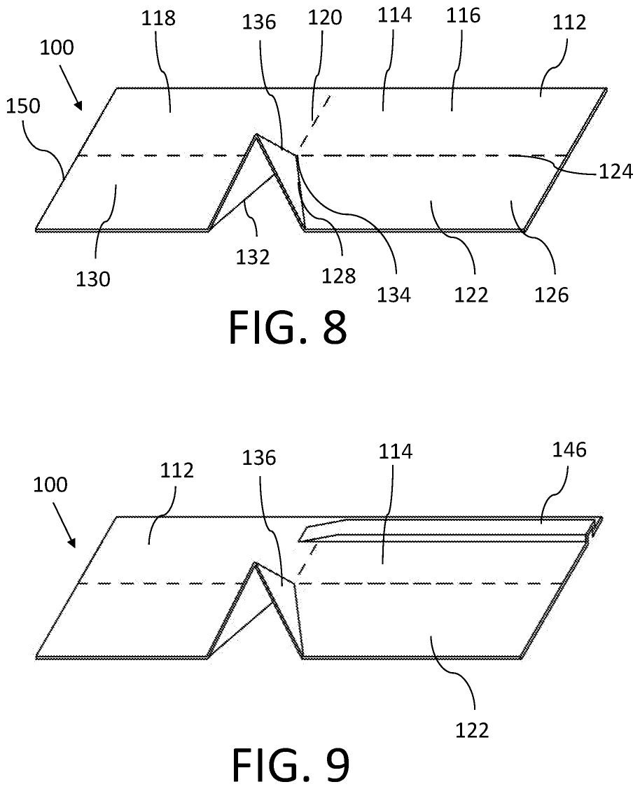

In one embodiment, flashing 100 is a window flashing, and more particularly, a corner for a window frame 138, which will be described with reference to FIG. 2. It will be understood that similar principles apply to flashing 100 as described above, and that its use as window flashing is a particular embodiment. Window flashing 100 has a sheet of material 112 that is foldable and substantially inelastic, and is preferably also water impermeable. Sheet of material 112 has a frame section 114 having a first frame portion 116 and a second frame portion 118, first frame portion 116 meeting second frame portion 118 at a first fold line 120. Sheet of material 112 also has a skirt section 122 that meets frame section 114 at a second fold line 124 that is perpendicular to first fold line 120. Skirt section 122 has a first skirt portion 126 with a first inner edge 128 and a second skirt portion 130 with a second inner edge 132 facing first inner edge 128. First inner edge 128 and second inner edge 132 meet at vertex 134 of first fold line 120 and second fold line 124. A connecting web 136 is connected between first inner edge 128 and second inner edge 132. In a rest position, as shown in FIG. 8, frame section 114 and first and second portions 126, 130 of skirt section 122 define a plane, and connecting web 136 extends outward from the plane. Sheet of material 112 may be vacuum formed to create connecting web 136, as well as any other features in sheet of material 112 as discussed further below. In a use position, as shown in FIG. 2, sheet of material 112 is folded along first fold line 120 and second fold line 124 to conform to a corner of a window 138 such that first frame portion 116 is angled relative to second frame portion 118 and skirt portions 126 and 130 extend away from frame section 114. Connecting web 136 maintains an uninterrupted surface between first inner edge 128 and second inner edge 132 as sheet of material 112 is folded. As used herein, it will be understood that maintaining an uninterrupted surface refers to connecting web 136 being unbroken and being a single continuous piece of material. It is not necessary to cut, tape, or otherwise alter connecting web 136 in order to go between the rest position of FIG. 8 and the use position of FIG. 2. Further, connecting web 136 is preferably not under tension when in the use position. For example, it is preferably not required to stretch connecting web 136 in order to accommodate the use position, and connecting web 136 is preferably not under any elastic stress when window flashing 100 is installed on window corner 138.

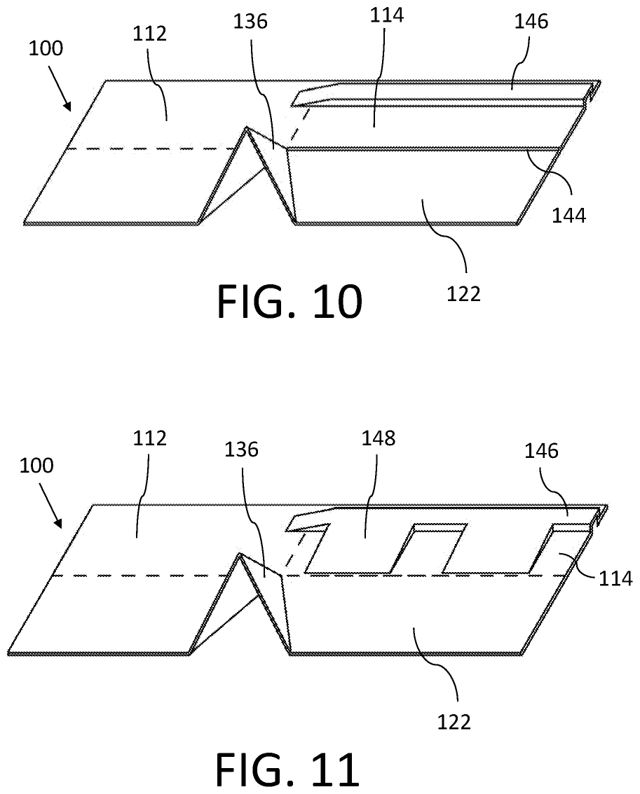

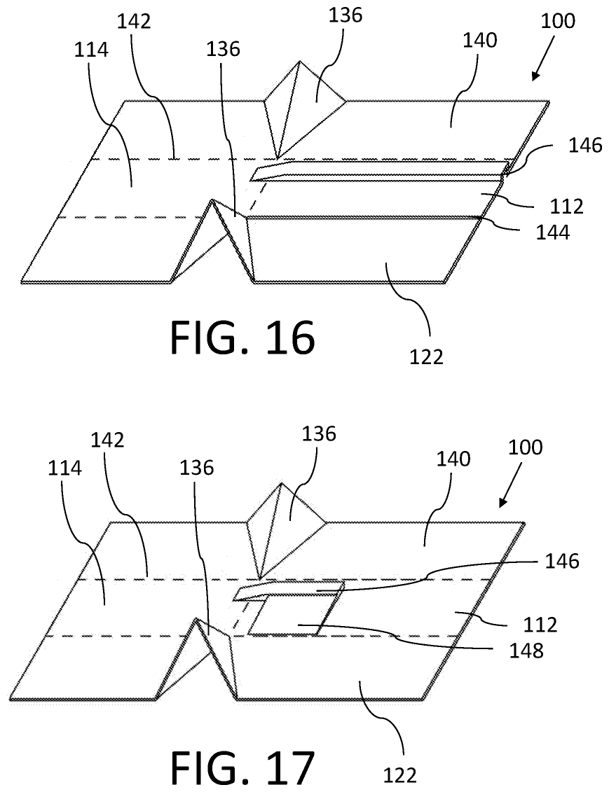

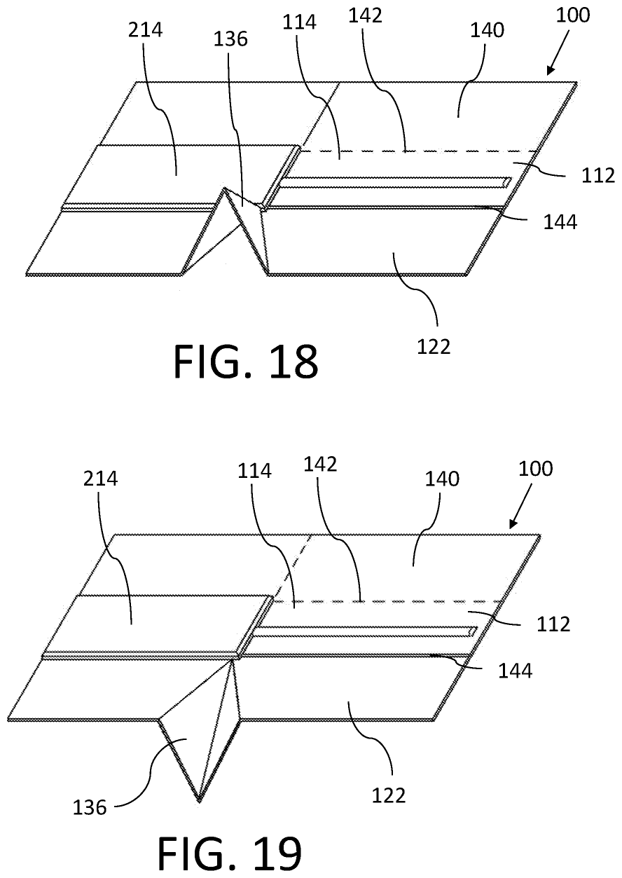

Referring to FIG. 16, sheet of material 112 may also have a rear skirt section 140 that meets frame section 114 at a third fold line 142 that is parallel to second fold line 124. As shown in FIG. 16, rear skirt section 140 may also have a connecting web 136, or, as shown in FIG. 18 and FIG. 19, rear skirt section 140 may be folded, cut, or stretched to accommodate window corner 138. Referring to FIG. 10 and FIG. 16, sheet of material 112 may also have a recess 144 along at least a portion of the length of second fold line 124. For example, recess 144 may extend outward away from window corner 138 and aid in folding and placement of sheet of material 112, or recess 144 may extend toward window corner 138 and form a drainage channel or other drainage structure. Referring to FIG. 9, frame section 114 may comprise a back dam 146 that defines a self-supporting portion of sheet of material 112 that extends out of the plane of sheet of frame section 114. Referring to FIG. 11, frame section 114 may comprise a raised portion 148 that slopes downward towards second fold line 124.

Sheet of material 112 is preferably foldable and substantially inelastic. However, it will be understood that it may be an elastic material such as a rubber sheet. Sheet of material 112 is also preferably a water impermeable material, and may also provide an air barrier. Connecting web 136 may be formed such that first inner edge 128 and second inner edge 132 extend from a vertex of first fold line 120 and second fold line 124 to an outer perimeter 150 of sheet of material 112, with at least first inner edge 128 being adjacent to skirt section 122. In this case, connecting web 136 is connected between first inner edge 128 and second inner edge 132. In the use position, sheet of material 112 may be folded along first fold line 120 and second fold line 124 to conform to window corner 138 such that first frame portion 116 is angled relative to second frame portion 118 and such that skirt section 122 and connecting web 136 extend away from frame section 114. Connecting web 136 maintains an uninterrupted surface between first and second inner edges 128, 132 and sheet of material 112 is folded.

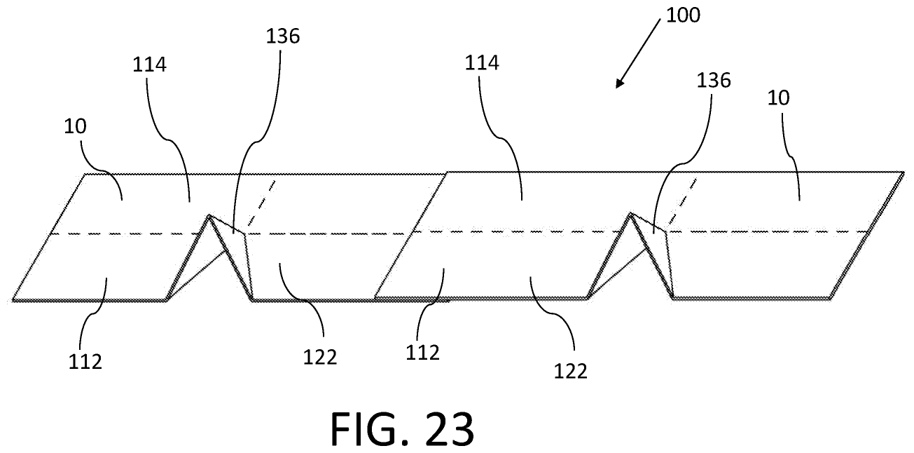

A method of installing flashing 100 in a window opening 138 of a wall will now be described. Window flashing 100 is provided in a rest position, where frame section 114 and first and second portions 126, 130 of skirt section 122 define a plane, and connecting web 136 extends outward from the plane. Sheet of material 112 is folded along first fold line 120 and second fold line 124 to conform to a corner of window opening 138 such that first frame portion 116 is angled relative to second frame portion 118 and skirt section 122 extends away from frame section 114. Connecting web 136 maintains an uninterrupted surface between first and second inner edges 128, 132 as sheet of material 112 is folded. Window flashing 100 is then placed into window opening 138 such that frame section 114 overlies at least a portion of an inner surface of the frame of the window 138 and such that the skirt section 122 and the connecting web 136 overlies at least a portion of a front face of the frame 138. Skirt section 122 may be folded to cover an exterior portion of the wall. Folding sheet of material 112 to conform to a corner of the window opening 138 preferably does not place connecting web 136 under tension. Where sheet of material further comprises rear skirt section 140 that meets the frame section a third fold line 142, the method may have the further step of folding sheet of material 112 along third fold line 142 to cover an interior portion of the wall. After placing window flashing 100 into window opening 138, window flashing 100 may be secured to window opening 138, such as by using adhesive, tape, or other securing devices that do no impair the weather barrier function of window flashing 100. The window may be installed in the opening, and may engage raised features on sheet of material 112, such as back dam 146. Referring to FIG. 23, a second window flashing 100 may also be placed into window opening 138, and at least a portion of the first and second window flashings 100 may be overlapped. Second window flashing 100 may be folded to conform to a second corner of window opening 138 as described above. As discussed above, the sheets of material that make up first and second window flashing 100 is foldable, and may be substantially inelastic and provide a water barrier.

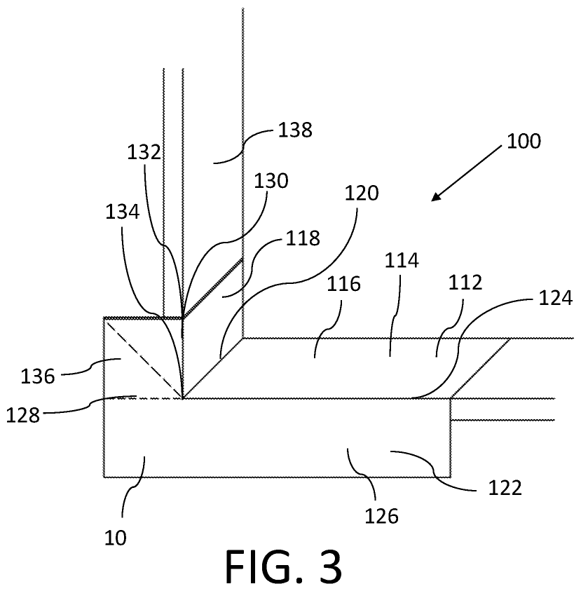

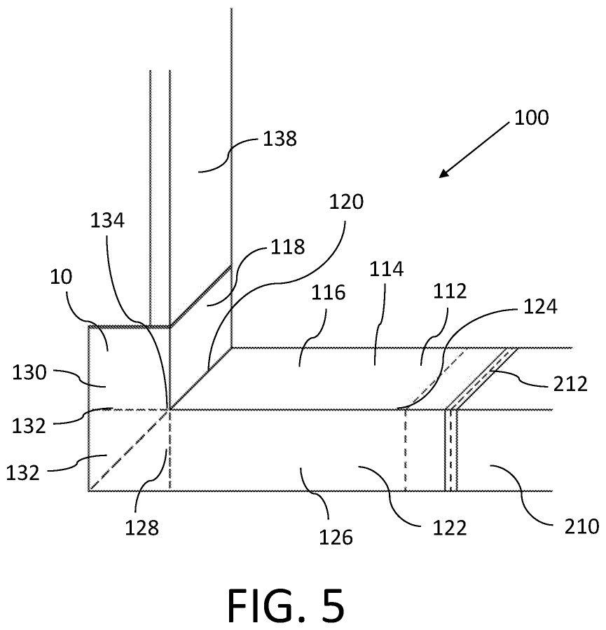

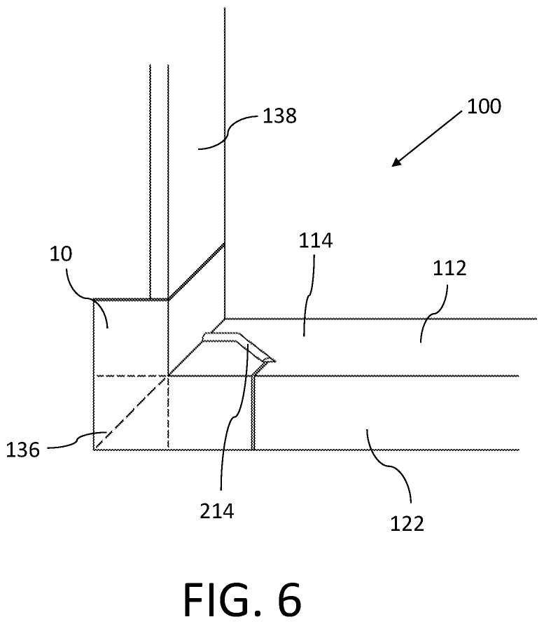

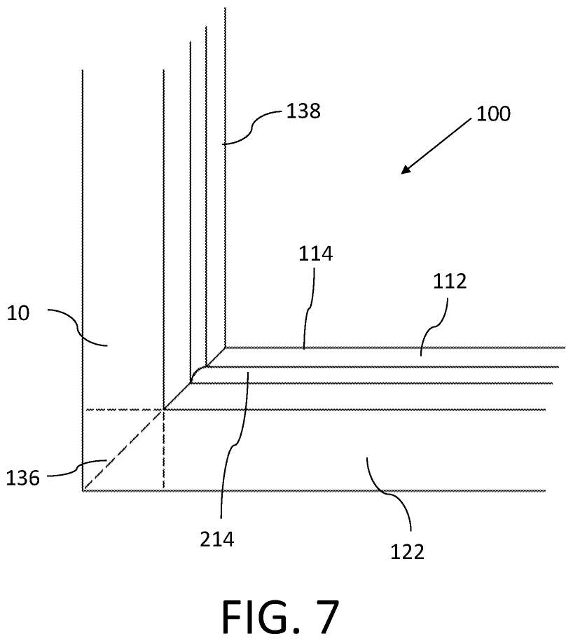

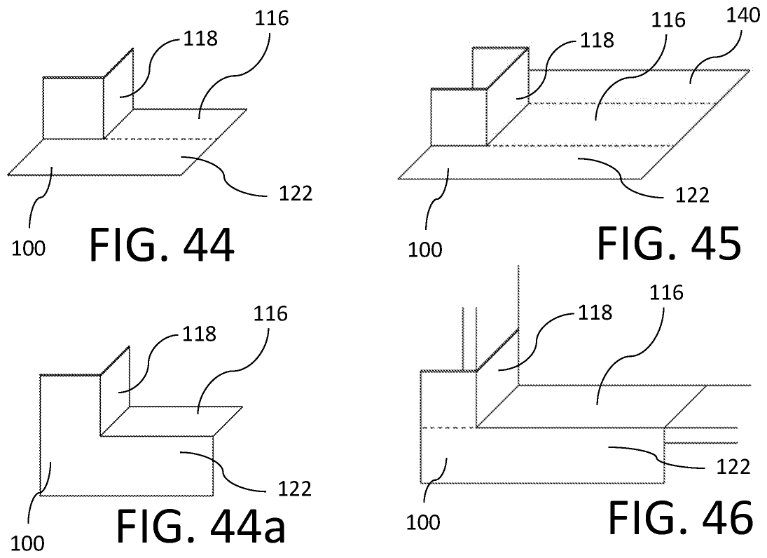

FIG. 1 shows an installation of a weather barrier 202, which is a variation of flashing 100 described above. As shown, wall 200 is depicted with weather barrier 202 surrounding the window opening in wall 200. Window 204 is placed in the opening, and may interact with raised features in weather barrier 202 such as back dam 206 or sloped surface 208. FIG. 2 shows a portion of weather barrier 202 that may be similar to window flashing 100 as described above, with connecting web 136 between first and second portions of skirt section 122. FIG. 3 shows similar window flashing 100, where connecting web 136 is placed between skirt section 122 and frame section 114. FIG. 4 depicts an embodiment where weather barrier 202 is a sheet 10 made up of a planar web 12 having a connecting web 20. The depicted embodiment may be used with other types of weather barriers, and may, for example, be used to protect the corners of the window opening, while the straight portions of the frame are covered by building wrap material, and the building wrap material is attached to the sheet 10. Similarly, as shown in FIG. 5, window flashing 100 may be overlapped with and taped to another weatherproofing material 210, such as with tape 212. FIG. 6 depicts window flashing 100 that extends along the lower portion of the window frame and has drainage features 214 formed in the surface. As shown in FIG. 6, this may include raised barriers to divert water flow, as well as drainage channels recessed into the surface to further direct water flow. While FIG. 6 depicts a number of drainage channels, it will be understood that by reversing the direction of the feature, these features could instead act as raised drainage barriers, and could divert fluid flow along the overlap by providing a raised barrier. FIG. 7 depicts window flashing 100 that extends around both the lower portion of the window frame and the side of the window frame. Window flashing 100 may traverse the entire window frame, and may be formed as a continuous piece, or may be overlapped and taped as appropriate to form a join on the window. In FIG. 7, drainage feature 214 is a central, rounded raised portion that may traverse the entire interior of the window and may seal against window 204 once installed. FIG. 44 and FIG. 45 depict window flashing 100 that is formed with either only front skirt section 122 or both front skirt section 122 and rear skirt section 140 in a plane with first frame section 116. Front skirt section and rear skirt section may then be folded down when window flashing 100 is installed, as shown in FIG. 46. As shown, second frame portion 118 may be vacuum formed. FIG. 45 and FIG. 46 demonstrate how this embodiment would be folded down along fold lines, which may be inherent in the design. It will be understood that any of the features discussed above and in the following paragraphs may be combined into a variety of working embodiments. For example, any number of connecting webs 20 and 136 may be incorporated to accommodate a given application, and any number of drainage features 214 and other raised portions may be included to accommodate any desired configuration.

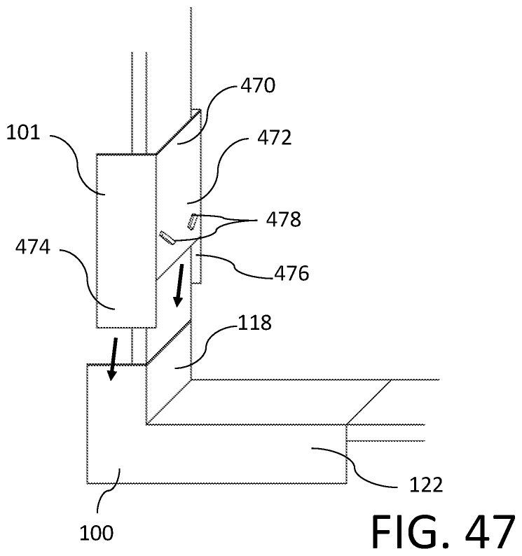

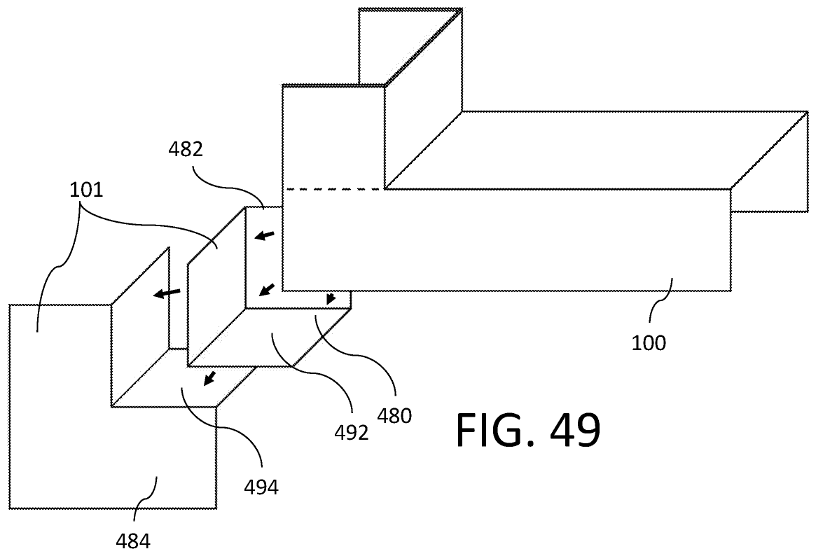

Sheet of material 10 may be installed with one or more secondary flashing components 101 that control flow of liquid around sheet of material 10. Secondary flashing components may be made from the same material as sheet of material 10 or other materials. FIG. 47 depicts window flashing 100 that has a side extension 470 that overlaps a portion of window flashing 100. As shown, side extension 470 may have a frame portion 472 that overlaps frame portion 118 of window flashing 100, a front skirt 474 that overlaps at least a portion of front skirt 122, and a back skirt 476 that overlaps at least a portion of rear skirt 140. The various components are overlapped to ensure water flows down and away from the frame or surface that it is being used to protect. Side extension 470 may have additional features such as flow diverters 478 that help to divert water onto window flashing 100 or in a desired direction. FIG. 48 and FIG. 49 depict window flashing 100 installed with one and two secondary sheets of material 101, respectively, shingled below window flashing 100 in additional contours of the window frame or surrounding building structure. For example, the two secondary sheets of material 101 may be used on a recessed window (not shown). Referring to FIG. 48, secondary flashing component 101 may be a corner piece 480 that has orthogonal faces, such as an inner wall facing portion 482 that is installed against wall 200 and covered directly by front skirt section 122, an outer wall facing portion 484, and a connecting portion 486. Referring to FIG. 49, outer wall facing portion 484 may be on one secondary flashing component 101 and inner wall facing portion 482 that has an overlapping portion 492 that overlaps an underlying portion 494 connected to outer wall facing portion 484. The examples shown in FIGS. 48 and 49 may be particularly useful when the surface is stepped, such as may be the case with some window or door frames. It will also be understood that the number of corners and faces required may be varied depending on the preferences of the user.

FIG. 8 depicts a portion of weather barrier 202 as described with respect to window flashing 100. However, it will be understood that it may also be sheet 10 as described above, or another example. FIG. 8 shows an embodiment with a single connecting web 136. FIG. 8 shows a drainage feature 214 in the form of a back dam 146. The depicted back dam is rectangular, and has a sloped portion that extends over first fold line 120 to prevent moisture travelling along first fold line 120. FIG. 10 depicts a similar embodiment having an additional recess 144 in the form of a molded corner portion along second fold line 124 that aids in placement and folding of sheet of material 112. FIG. 11 depicts a back dam 146 and a sloped portion 148. Sloped portion 148 depicted in FIG. 11 is intermittent along the length of back dam 146, however, it will be understood that sloped portion 148 may also be continuous. The breaks in sloped portion 148 may be provided to allow window shims to be placed in required locations to support window 204. It will be understood that window shims may be placed in designated breaks in drainage features 214, window shims may be placed directly onto drainage features 214, or window shims may be placed under drainage features 214, such that the window shims contact the window frame, and weather barrier 202 is placed over the window shims. Preferably, as window shims are integrally formed with sheet of material and made from the same material, are collapsible when sufficient force is applied, such as may be applied when being installed under a window or door. Similar shims may be included in any of the embodiments depicted herein, and may be designed to provide a certain level of support, and to be collapsible or crushable under a predetermined load that may provide support when installing a window or door. The shims may be used in conjunction with, or to support more rigid shims that are used when installing windows or doors (not shown).

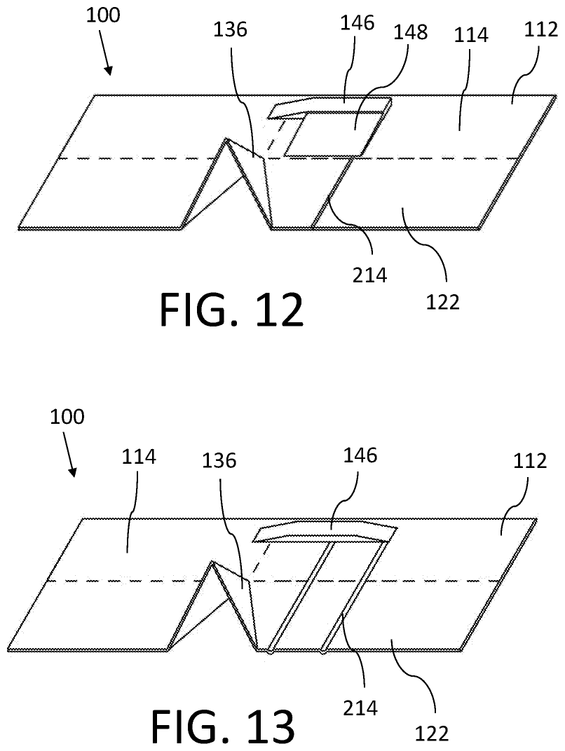

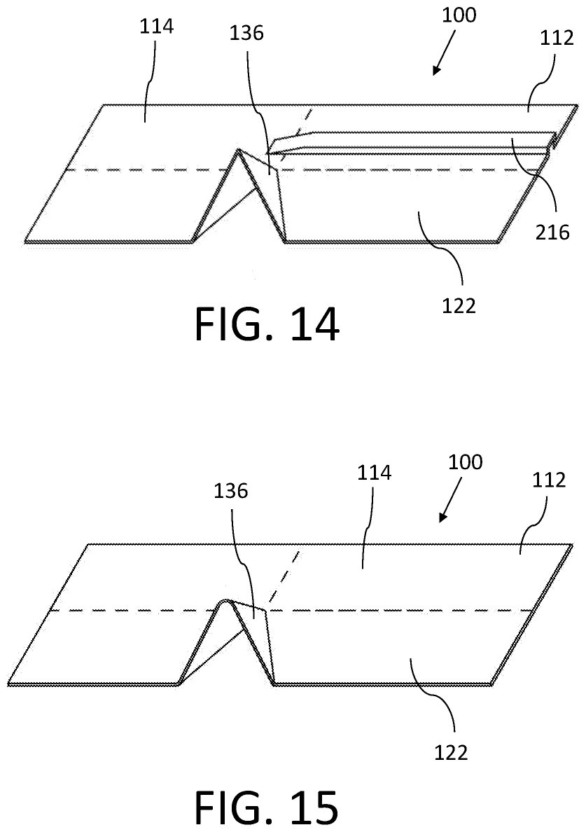

In another example, as shown in FIG. 12, back dam 146, sloped portion 148, and drainage feature 214 may be provided along first fold line 120. FIG. 13 depicts an alternative embodiment having a sloped back dam 146 and two drainage channels 214. It will be understood that back dam 146 may also be replaced with a water barrier at different locations along frame section 114, such as the front dam 216 shown in FIG. 14. It will also be understood that while the corners and edges depicted in connecting web 20, 136 have a straight fold line, as shown in FIG. 14, any of the folds in sheet 10 or window flashing 100 may also be rounded, depending on the requirements of the application. For example, FIG. 15 depicts a connecting web 136 having a rounded interior edge.

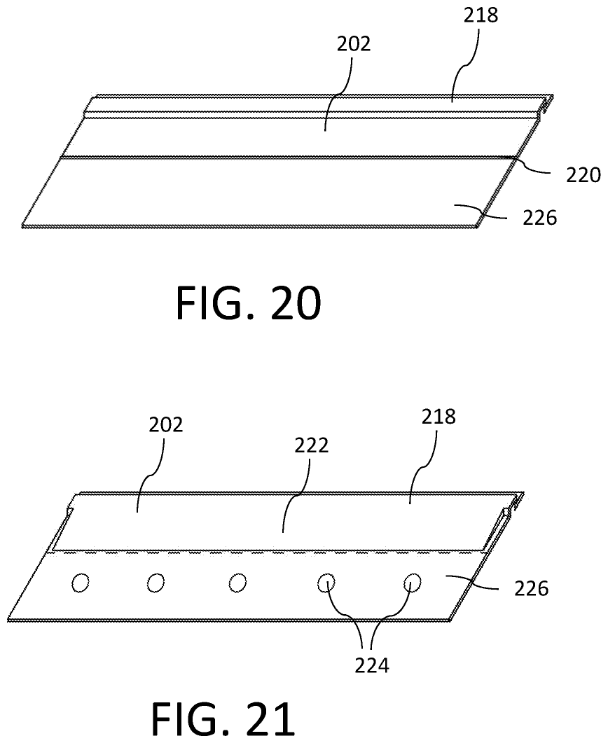

Referring to FIG. 16 and FIG. 17, and as discussed above, window flashing 100 may have both a front skirt section 122 and a rear skirt section 140, and may have multiple connecting webs 136. Drainage features 214 as discussed above may also be incorporated into these embodiments. Referring to FIG. 18 and FIG. 19, which both depict a drainage feature 214 that is placed on more than one portion of the frame section 114, connecting web 136 may also vary in orientation relative to the drainage features, and may extend in the same direction, as shown in FIG. 18, or in the opposite direction, as shown in FIG. 19. Sheet 10 and window flashing 100 may also be used in combination with sections of weather barrier 202 that do not have a connecting web 136, such as through overlapping and other attachment means. These portions of weather barrier 202 may be used as extensions to allow for different sizes of openings to be accommodated or may be used where only a corner portion is provided, such as is shown in FIG. 4. Referring to FIG. 20, a portion of weather barrier 202 having a back dam 218 and a recess 220 to accommodate folding is shown. Referring to FIG. 21, a portion of weather barrier 202 having a back dam 218, a sloped portion 222, and protrusions 224 from a wall cover portion 226 are shown. Protrusions 224 may, for example, be vacuum formed bumps that create air channels between wall cover portion 226 and a wall cover material such as drywall that is placed over weather barrier 202.

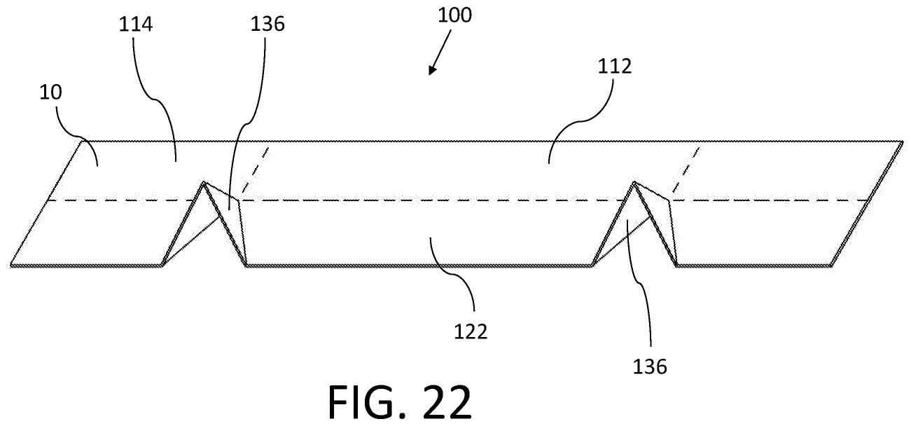

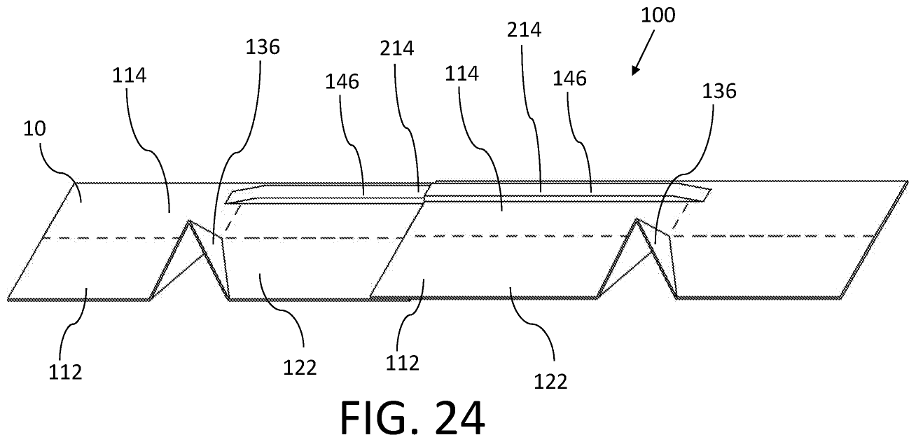

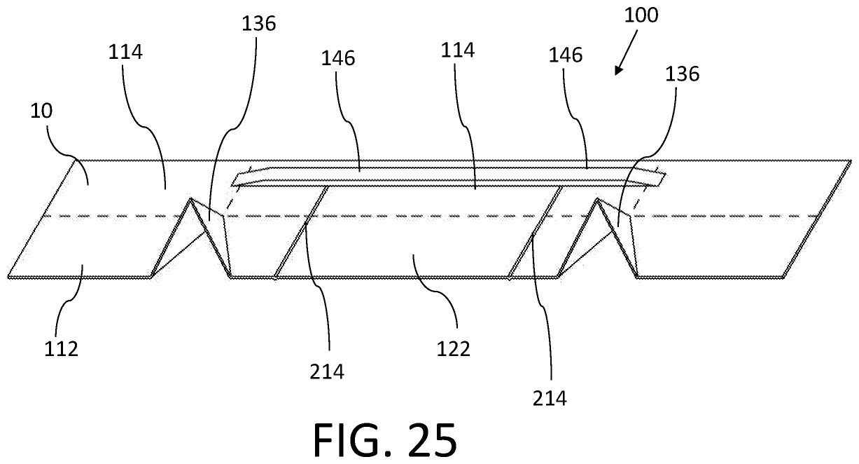

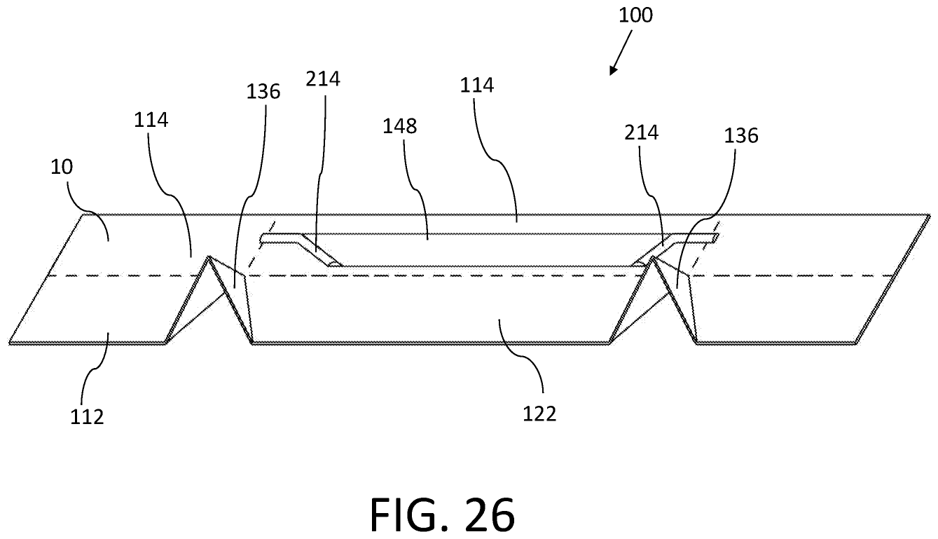

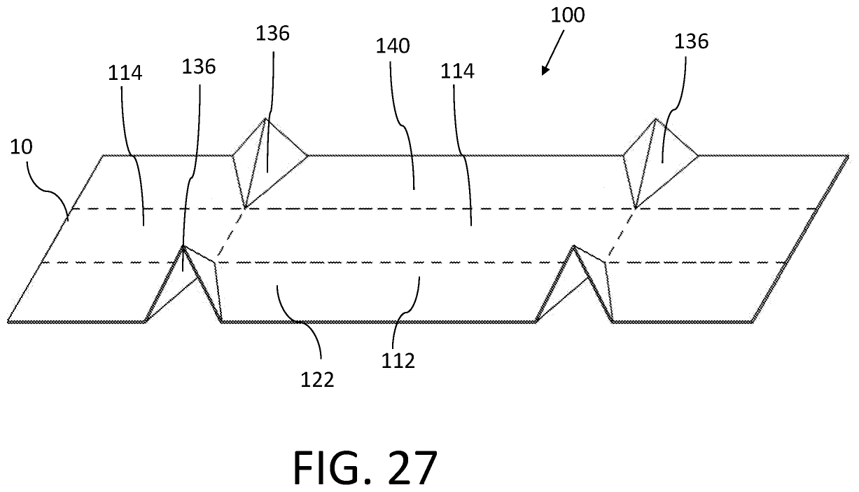

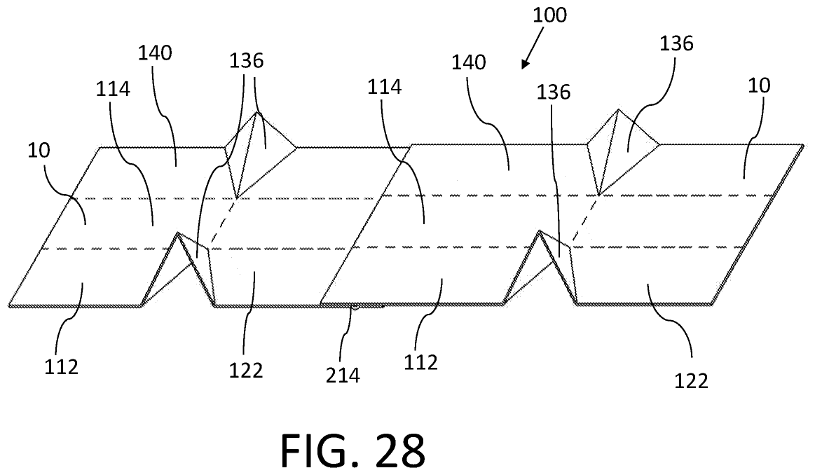

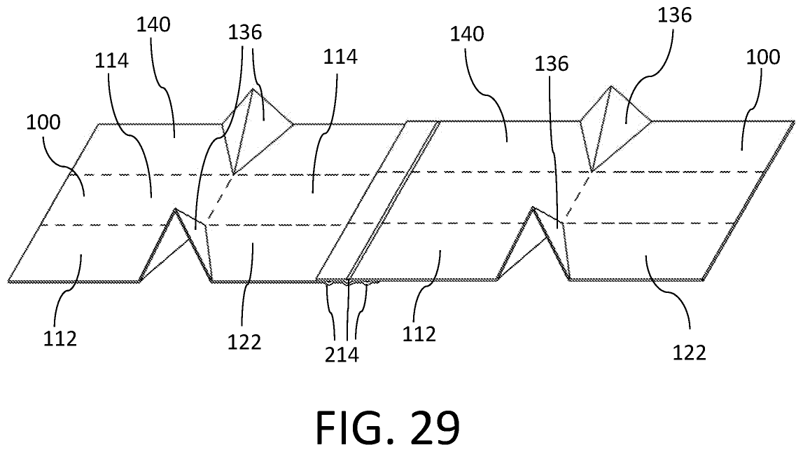

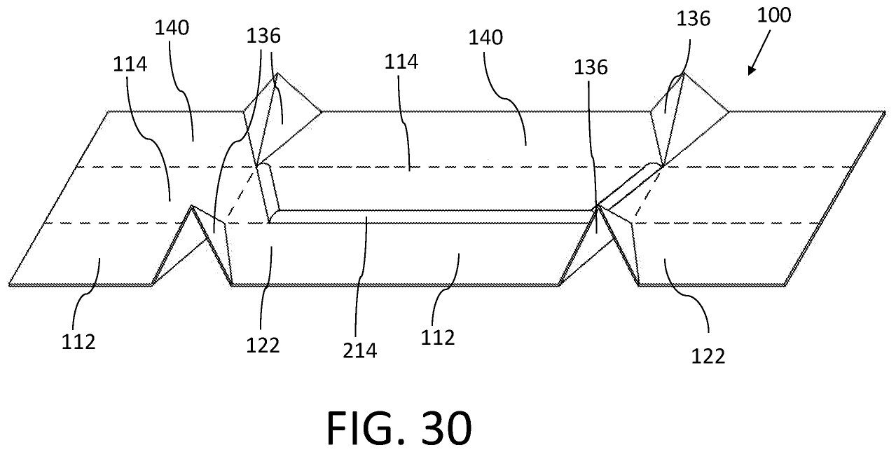

Referring to FIG. 22, window flashing 100 may also have multiple connecting webs 136 formed in skirt section 122. This may allow a single piece of window flashing 100 to accommodate both lower corners of a window frame. This may also be accomplished by overlapping two pieces of window flashing 100 as shown in FIG. 23. The pieces of window flashing may have complementary drainage features 214 such as back dams 146 that overlap and interlock with each other as shown in FIG. 24. Different drainage features 214 as discussed above may also be provided on embodiments with a single window flashing 100 with multiple connecting webs. For example, FIG. 25 shows a back dam 146 a drainage channels extending over skirt section 122 as drainage features 214. FIG. 26 shows raised drainage features 214 in combination with a sloped portion 148 to direct the flow of fluids. FIG. 27 shows an embodiment having both a front skirt section 122 and a rear skirt section 140, each having a connecting web 136. This allows for corners to be covered on the front and back sides of the entire lower window frame. It will be understood that more connecting webs 136 may also be provided, depending on the application. For example, eight connecting webs may be provided to accommodate front and back corners around an entire rectangular window frame. As discussed above, a similar number of corners may also be covered by multiple pieces of window flashing 100 which may be overlapped and attached together. As shown in FIG. 28 and FIG. 29, drainage features 214 may be provided in the overlap section to allow water that enters the overlap section to be removed. In FIG. 28, a single drainage channel is formed in the overlap area, while in FIG. 29, three drainage channels are formed. The drainage channels may be placed in one or both sheets. Referring to FIG. 30, drainage feature 214 may also be a front dam with raised portions to direct fluid flow. In some cases, the area behind the front dam may be filled with insulation.

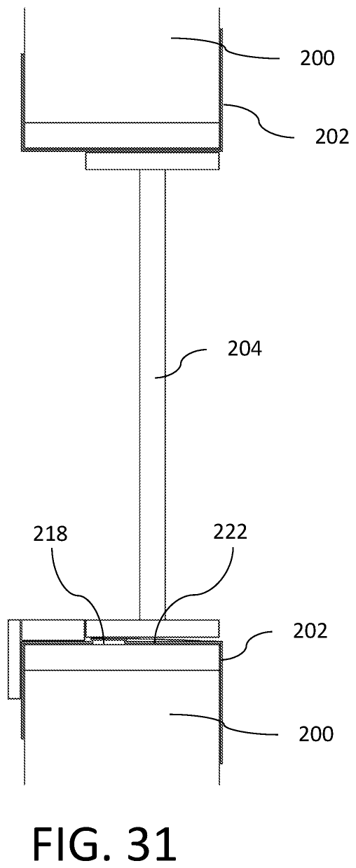

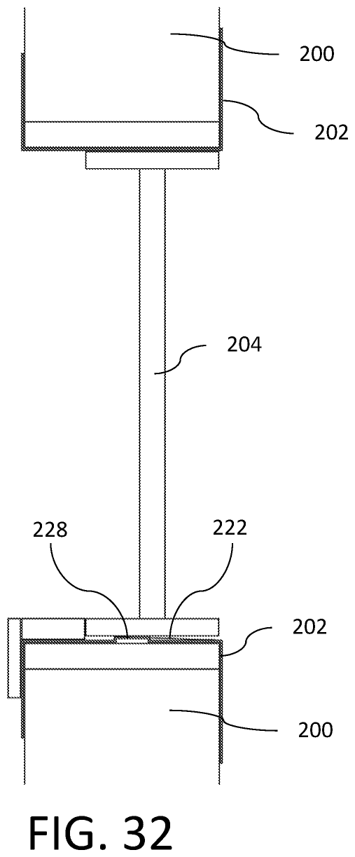

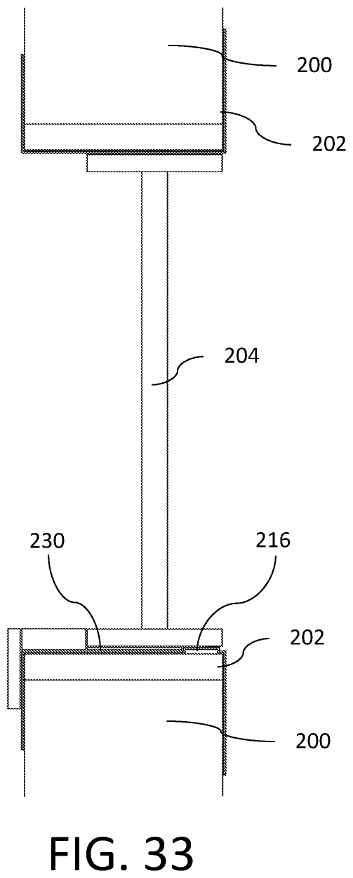

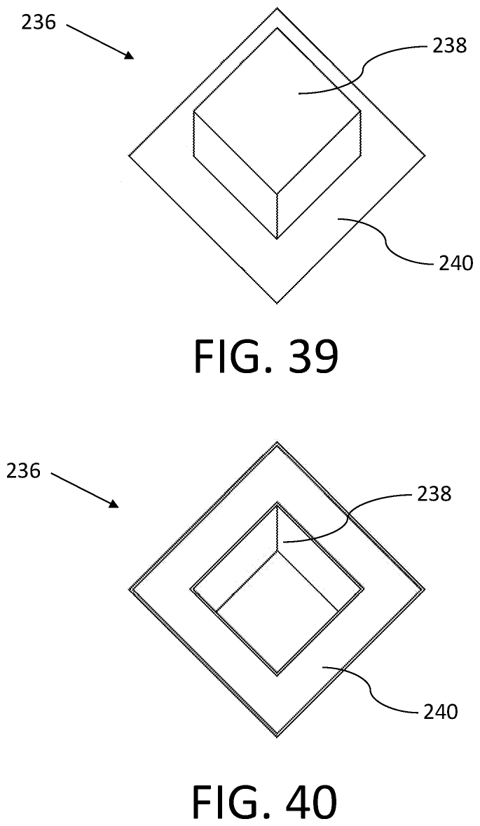

Referring to FIG. 31 through FIG. 33, one embodiment with weather barrier 202 installed around window 204 is shown. In FIG. 31, a back dam 218 is provided, along with a sloped portion 222. In FIG. 32, a central dam 228 spaced near the center of window 204 is provided, along with a sloped portion 222. In FIG. 33, a front dam 216 is provided. Opening 230 may be filled with insulation if desired in the application. FIG. 34 shows a detailed view of how weather barrier 202 may interact with the interior face of the wall 200. The air gap between window 204, wall 200, and wall cover material 232 may be blocked by a fold 234 in weather barrier 202. Back dam 218 is also shown, along with a window shim 236 placed under window 204. Window shim 236 is shown in more detail in FIG. 39 through FIG. 42 as a separate element from sheet 10, although as discussed above, it may also be integrally formed with sheet 10. In particular, it will be understood that the various shapes shown in FIGS. 39-42 may be formed separately or integrally with sheet 10. The location of back dam 218 may be varied based on the preferences of the user and the intended application. For example, back dam 218 may be at the back edge of weather barrier 202, or at an intermediate location between the front and the back.

Window shim 236 is preferably vacuum formed from a foldable material similar to that used for sheet 10 and window flashing 100, such that it creates a self-supporting portion 238 that is sufficiently rigid that it can support window 204 and act as a shim. Window shim 236 also has a frame portion 240 that can be attached to a surface. For example, frame portion 240 may be self-adhesive and covered by a film that may be peeled away from frame portion 240. As shown, shim 236 may take a variety of shapes. It will be understood that other shapes may be used, such as triangular prisms or any other shape that provides sufficient rigidity to the foldable material to allow the shim 236 to support a window 204 or door, while still being collapsible when sufficient force is applied.

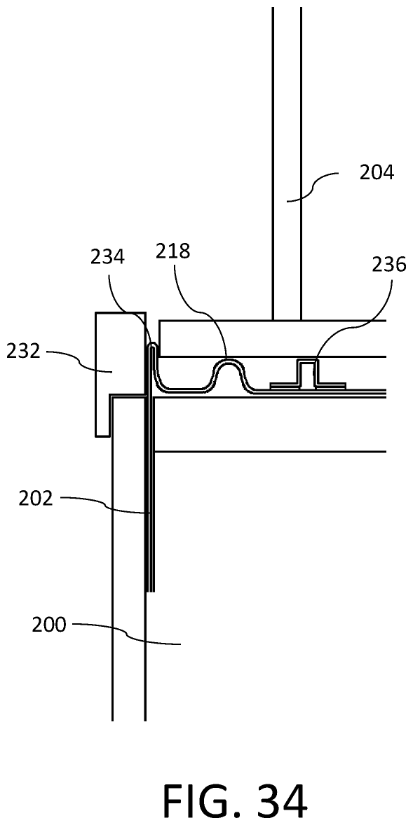

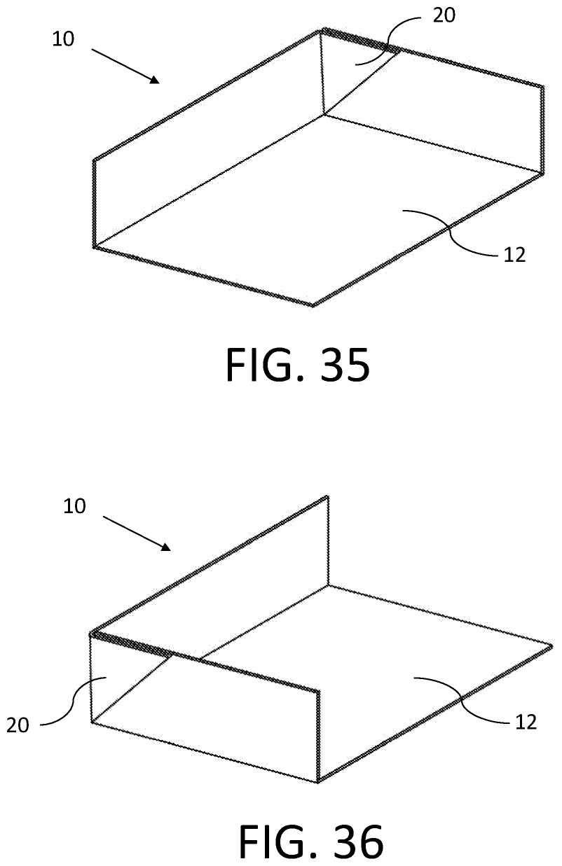

In the figures discussed above that use a connecting web, connecting web 20 and 136 is shown extending over a corner. However, it will also be understood that similar principles may be applied to create an interior folded corner, such as to create a waterproof shower pan barrier. Referring to FIG. 35 and FIG. 36, connecting web 20 may also be folded to create a structure with sheet 10 that has a raised sidewall as shown. Referring to FIG. 37 and FIG. 38, sheet 10 may also be used to form corners on roof flashing, as described further above. Referring to FIGS. 43 and 48, flashing 100 may also be formed in a shape that substantially conforms to the surface on which it will be installed. Referring to FIGS. 44 and 45, flashing 100 may have a skirt portion 122, on one or both sides, that may be folded down to cover the sides of a frame, while central section 116 covers the frame, as shown in FIG. 46. Referring to FIGS. 44a, and 47, flashing 100 may also be formed with skirt portions 122 extending downward without needing to be folded along a fold line. Other combinations are also possible. For example, skirt portion 122 may be formed at an angle on one side, and may be foldable on the other, which may allow flashing 100 to be installed, for example, in a door frame, or other opening that has a surface that is flush or nearly flush to the rough opening. Alternatively, referring to FIG. 48, the fold line may be vertical, instead of horizontal, where skirt 122 may be folded around the vertical portion of the rough opening.

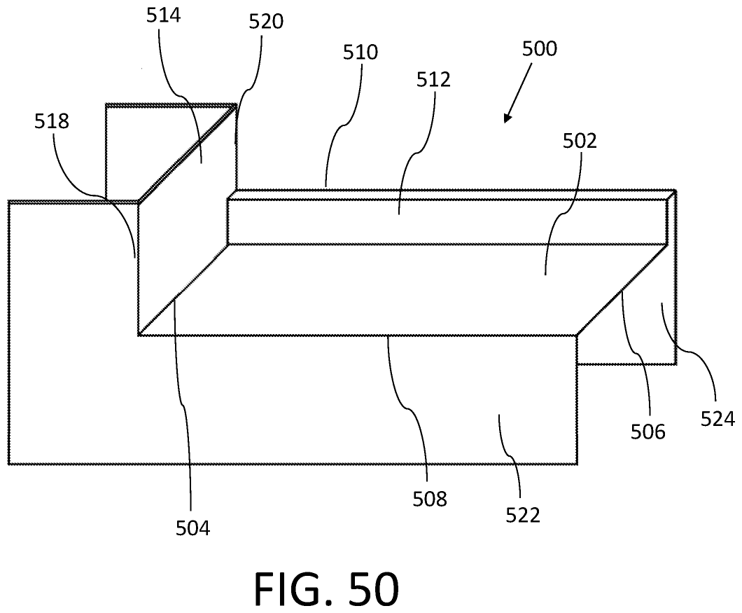

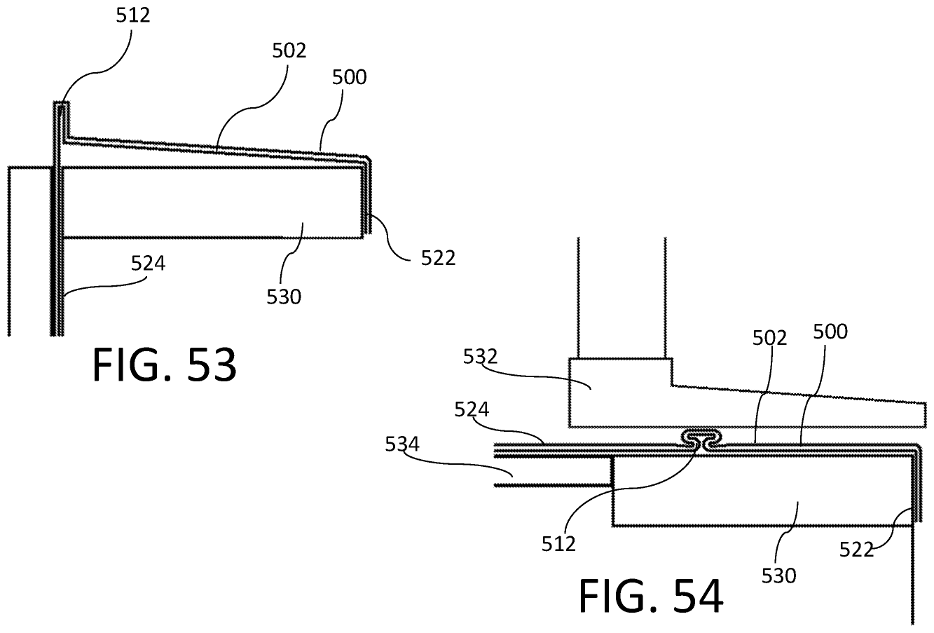

Referring to FIG. 50 through FIG. 54, one embodiment of sheet of material 10 is a sill pan 500 for a building opening such as a window opening or doorway. Sill pan 500 has a bottom plate 502 that has a first end 504, a second end 506, a front edge 508, and a rear edge 510. Bottom plate 502 may have one or more protrusions; the protrusions may define at least a moisture-directing profile 512 as shown, or may be as otherwise shown in other examples discussed herein. Sill pan 500 has an end wall 514 located at first end 504 of bottom plate 502 which extends substantially away from the first end in a direction that is substantially perpendicular to bottom plate 502. End wall 514 has a front edge 518 and a rear edge 520 which are coplanar with the front edge 508 and rear edge 510 of the bottom plate, respectively. A front skirt 522 is connected to front edge 508 of bottom plate 502 and front edge 518 of end wall 514; a rear skirt 524 is connected to rear edge 510 of bottom plate 502 and rear edge 520 of end wall 514. Front skirt 522 and rear skirt 524 may be the of similar size, such as in FIG. 50 to FIG. 52, or they may be of different sizes, as shown in FIG. 53 and FIG. 54. In other embodiments, sill pan 500 may not have either a rear skirt 524 or a front skirt 522, depending on the other components that are to be installed.

Bottom plate 502, end wall 514, front skirt 522, and rear skirt 524 are preferably vacuum formed as a unitary body from a foldable material, as discussed above. Bottom plate 502 is formed such that it may be self-supporting in a no-load condition, or when properly supported, and is conformable under a load applied during installation in the building opening. At the very least, self-supporting is intended to mean the general shape is maintained and in particular, the folds or edges, even though some bending of the planar portions may occur under its own weight. For example, bottom plate 500 may be considered self-supporting in a no-load condition by maintaining its general shape is maintained when sill pan 500 is at rest before installation, without any external loads or forces. Any protrusions formed in bottom plate 502 will also be self-supporting in a no-load condition, and will generally be more rigid than the rest of bottom plate 502 as the corners and edges used to form the protrusions will enhance the rigidity of the structure.

While bottom plate 502 is preferably self-supporting, it should be conformable to loads that are applied during installation by an installer or the other components being installed along with sill pan 500, such as a window or door being installed.. Other loads may include fasteners that hold sill pan 500 in place, folds or creases made by an installer, or surface irregularities in the rough opening, window, or door. For example, bottom plate 502 may conform to the shape of a component installed on top of sill pan 500 or it may conform to the features of the sill upon which sill pan 500 is installed. In an arrangement in which adjacent sill pan sections are overlapping, an example of which is shown in FIG. 52, sill pan 500 will be sufficiently conformable to match the underlying surface, without and additional space required beyond the thickness of the material.

FIG. 54 depicts a door 532 installed on top of sill pan 500 and sill 530, which cause bottom plate 502 and to conform to the shape of sill 530 and door 532. As shown, moisture directing profile 512 also conforms to sill 530 and door 532. In one example, bottom plate 502 may conform to one load during a first installation of door or window, and then conform to a different load during a second installation, such as when a door or window is replaced.

Sill pan 500 may be formed such that, in a no-load condition, front skirt 522 and rear skirt 524 extend substantially parallel to bottom plate 502 and are foldable relative to the bottom plate. This may include skirts that are formed in the same plane as bottom plate 502, or skirts that are formed partially parallel to bottom plate 502.

As depicted, moisture directing profile 512 is immediately adjacent to rear edge 510 of sill pan 500, however it will be understood that moisture-directing profile 512 or other protrusions may be located at any location on bottom plate 502, and sill pan 500 may have other drainage features as discussed above. Protrusions in bottom plate 502 may extend along a width of the bottom plate, along a length of the bottom plate, or they may extend along a combination of the width and length of the bottom plate. Bottom plate 502 may have shim protrusions that are collapsible when a sufficient load is applied during installation. Other protrusions may be designed to be collapsible or crushable under the load, such as moisture directing profile 512, as shown in FIG. 54. The crushable protrusions may be designed to at least partially undergo plastic deformation under the load, such that they may remain at least partially deformed when the load is removed. As depicted in FIG. 53, bottom plate 502 may be formed or installed such that bottom plate 502 is sloped toward front edge 508, such that water any water that enters below the window or door installed thereon is encouraged to flow out toward front edge 508. Depending on the installation, bottom plate 502 may be sufficiently self-supporting, particularly with additional support obtained by taking skirts 522 and 524 in place, that no additional structure is required to maintain the sloped orientation. In other circumstances, a piece of material, such as strapping or shims (typically 1/4 or 1/2 inch), may be installed below bottom plate 502 to provide support. Bottom plate 502 is sufficiently conformable to accommodate any appropriately sized supporting material. The slope may be provided during the vacuum-forming process, as assumed in the discussion above, or during installation by raising rear edge 510 during installation and appropriately attaching rear skirt 524 to support rear edge 510 at a higher elevation than front edge 508, or by using a piece of material below bottom plate 502. In either approach, the conformability of the material may permit the slope to be formed.

Sill pan 500 may include other components that are installed in an overlapping manner with sill pan 500, such as side extensions 470, shown in FIG. 47 that are sized to overlap a portion of the front skirt and the rear skirt and overlap at least a portion of the end wall. Sill pan 500 may have a corner piece 480, shown in FIG. 48 and FIG. 49, with first, second, and third orthogonal faces that is overlapped by front skirt 522 adjacent to first end 504 and end wall 514.

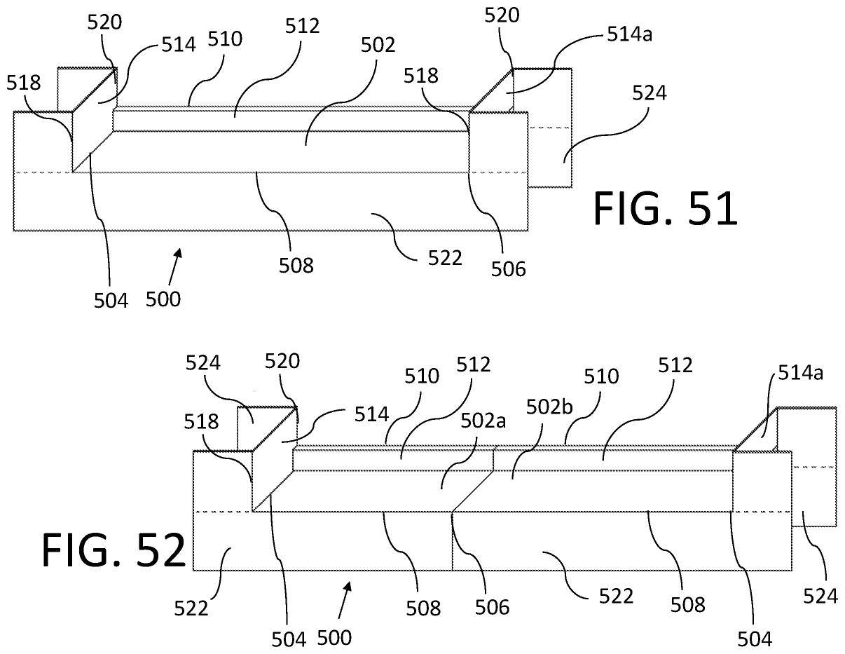

Referring to FIG. 51, sill pan 500 may be designed to extend along the length of a bottom of a window or doorway and as such preferably has a second end wall 514a at second end 506 of bottom plate 502 opposite first end wall 514.Referring to FIG. 52, sill pan 500 may be made of two pieces that overlap as discussed above. As the material from which sill pan 500 is generally pliable, the overlap is able to conform to the underlying portion at any point along the length of sill pan 500 to minimize interference and thickness when installed, while still being sufficiently resilient to facilitate installation of sill pan 500. This may be contrasted to a more flexible material, which is more difficult to handle and requires more care in aligning the components; and compared to more rigid materials, which would cause the material to bend along its length such that the overlapping end is raised, potentially interfering with the window or door being installed. Similar principles may also apply to other embodiments described herein.

Sheet of material 10 may be formed with a textured surface 430. All or part of sheet of material 10 may be textured surface 430. In one example, shown in FIG. 43, window flashing 100 has textured surface 430 of circular indentations in the material that may allow airflow between window flashing 100 and the structure upon which it is installed. It will be understood that other texture patterns may be used depending on the specific application of sheet of material 10.

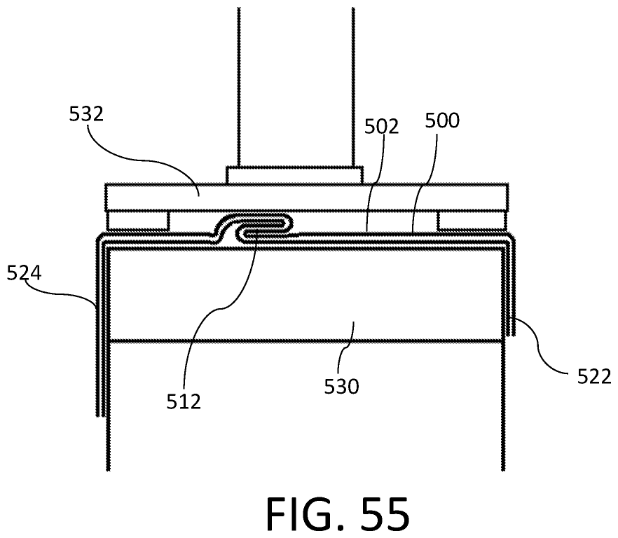

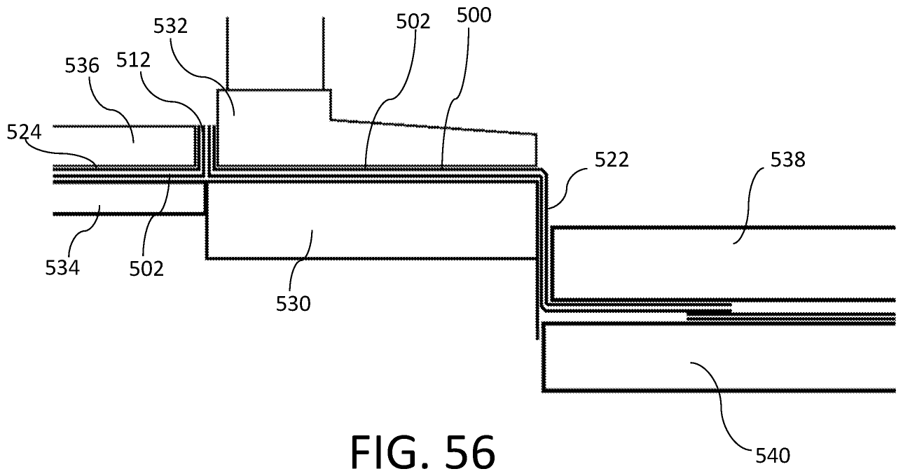

Referring to FIGS. 54 and 55, a dam 512 may be provided along bottom plate 502 that helps either achieve a seal or at the very least prevent the flow of water below a window or door toward the interior of a building, and away from any materials that may be damaged by exposure to water. As shown in FIG. 54, dam 512 may be designed to be crushed when a window or door is installed, or to fold over as shown in FIG. 55. In either case, dam 512 is likely to remain in contact with the window or door, and help prevent the flow of moisture. Alternatively, referring to FIG. 56, dam 512 may be designed to be installed behind the window or door, and may be attached to the lower edge to provide a different way of protecting against moisture without crushing or folding dam 512. It will be noted that the crushing or folding of dam 512 will typically occur after sill pan 500 has been installed.

Referring to FIG. 56, sill pan 500 may be designed to tie into the rest of the structure, such as flooring when installed as part of a door, or a low-lying window. As can be seen, rear skirt 524 may extend backward without being folded, which in some circumstances, may allow it to tie into the flooring, such as by being positioned between subfloor 534 and interior flooring 536. At the same time, front skirt 522 may tie into external flooring material such as between decking 538 and a subdeck 540. This may be used to protect the window, door, of the materials immediately adjacent to the opening.

Sill pan 500 as described above may be used in a method of waterproofing a bottom end of a building opening and example of which will now be described. The building opening is formed in a wall having a first face and a second face, and the building opening is defined by a bottom surface, side surfaces, and a top surface. Sill pan 500 is positioned in the building opening such that the bottom plate 502 extends along the bottom surface of the building opening, the first end wall 514 and the second end wall 514 extend along a portion of the side surfaces, the front skirt 522 extends parallel to the first face of the wall, rear skirt extends parallel to the second face of the wall. Positioning sill pan 500 may include positioning a two-part sill pan 500 with a bottom plate 502 that has a first part 502a and a second part 502b that overlaps the first part, as shown in FIG. 52. A load, as discussed above, is applied to sill pan 500, which conforms bottom plate 502 to the load.. A window frame or door frame may be installed in building opening. The window or door frame may apply the load to bottom plate 502 entirely, or it may apply a partial load in addition to other forces on bottom plate 502 during installation. The forces applied to bottom plate 502 by a window frame, door frame, or other load may cause at least a portion of protrusions 512 on bottom plate 502 to at least partially collapse toward bottom plate 502. The method may include a step of folding down front skirt 522 and back skirt 524 to extend parallel to the first and second faces of the wall, respectively, if they are vacuum formed in a plane parallel to bottom plate 502 in a no-load condition. Sill pan 500 may be positioned such that bottom plate 502 lies against the bottom surface of the building opening, or it may be installed such that all or a portion of bottom plate 502 is spaced from the bottom surface of the building opening.

The method may include the step of installing additional components with sill pan 500. Sill pan 500 may be positioned within the building opening first, and side extensions 470 may be installed after, such that side extensions 470 overlap at least a portion of end walls 514. In another example, a corner piece 480 having first, second, and third orthogonal faces is positioned against the first wall face, and sill pan 500 is positioned such that corner piece is at least partially overlapped by front skirt 522. Corner piece may also be positioned against the second wall face, and at least partially overlapped by rear skirt 524.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed is:

1. A sill pan for a building opening, comprising:
a bottom plate having a first end, a second end, a front edge, and a rear edge;
an end wall located at the first end of the bottom plate, the end wall extending substantially away from the first end in a direction that is substantially perpendicular to the bottom plate, the end wall having a front edge and a rear edge, the front edge of the end wall being coplanar with the front edge of the bottom plate and the rear edge of the end wall being coplanar with the rear edge of the bottom plate;
a front skirt that is connected to the front edge of the bottom plate and the front edge of the end wall;
wherein the bottom plate, the end wall, the front skirt and the rear skirt being vacuum-formed as a unitary body, the unitary being made from a foldable material, the bottom plate being self-supporting in a no-load condition and conformable under a load applied during installation in the building opening.

2. The sill pan of claim 1, wherein the bottom plate comprising one or more protrusions that define at least a moisture-directing profile.

3. The sill pan of claim 2, wherein the one or more protrusions comprise crushable protrusions that at least partially undergo plastic deformation under the load applied during installation.

4. The sill pan of claim 1, wherein the load comprising a force applied between a bottom of a sill and a door or a window.

5. The sill pan of claim 1, further comprising a second end wall at the second end of the bottom plate, the second end wall extending substantially away from the second end in a direction that is substantially perpendicular to the bottom plate.

6. The sill pan of claim 1, wherein the protrusions extend along a width of the bottom plate, along a length of the bottom plate, or a combination of along the width and length of the bottom plate.

7. The sill pan of claim 1, wherein the protrusions further comprise shim protrusions that are collapsible when a sufficient load is applied.

8. The sill pan of claim 1, further comprising a corner piece having first, second, and third orthogonal faces, the corner piece being sized and shaped to be overlapped by the front skirt adjacent to the first end of the end wall.

9. The sill pan of claim 1, further comprising a side extension that is sized to overlap a portion of the front skirt and at least a portion of the end wall.

10. The sill pan of claim 1, wherein, in a no-load condition, the front skirt extends substantially parallel to the bottom plate and is foldable relative to the bottom plate.

11. The sill pan of claim 1, wherein the rear edge of the bottom plate is raised relative to the front edge.

12. The sill pan of claim 1, further comprising a rear skirt that is connected to the rear edge of the bottom plate and the rear edge of the end wall.

13. A method of waterproofing a bottom end of a building opening, the building opening being formed in a wall having a first face and a second face, the building opening being defined by a bottom surface, side surfaces, and a top surface, the method comprising the steps of:
providing a sill pan comprising:
a bottom plate having a first end, a second end, a front edge, and a rear edge;
a first end wall located at the first end of the bottom plate, and a second end wall located at the second end of the bottom plate, the first end wall and the second end wall extending away from the bottom plate in a direction that is substantially perpendicular to the bottom plate, each of the first end wall and the second end wall having a front edge that is coplanar with the front edge of the bottom plate, and a rear edge that is coplanar with the rear edge of the bottom plate; and
a front skirt that is connected to the front edges of the bottom plate, the first end wall, and the second end wall;
wherein the sill pan is vacuum-formed as a unitary body, the unitary body being made from a foldable material, the bottom plate being self-supporting in a no-load condition;
positioning the sill pan in the building opening such that the bottom plate extends along the bottom surface of the building opening, the first end wall and the second end wall extend along a portion of the side surfaces, the front skirt extending parallel to the first face of the wall; and
applying a load to the sill pan, the bottom plate of the sill pan conforming to the applied load.

14. The method of claim 13, wherein the bottom plate comprises protrusions that define at least a moisture-directing profile.

15. The method of claim 14, wherein the one or more protrusions comprise crushable protrusions that at least partially undergo plastic deformation under the load applied to the sill pan.

16. The method of claim 13, wherein the bottom plate comprising a first part and a second part that overlaps the first part.

17. The method of claim 13, further comprising the step of installing a window frame or a door frame such that the window frame or door frame applies a force to cause at least a portion of the protrusions to at least partially collapse toward the bottom plate.

18. The method of claim 13, wherein the protrusions extend along a width of the bottom plate, along a length of the bottom plate, or a combination of along the width and length of the bottom plate.

19. The method of claim 13, further comprising the step of positioning a corner piece having first, second, and third orthogonal faces such that the corner piece is overlapped by the front skirt adjacent to the first end of the end wall.

20. The method of claim 13, further comprising the step of installing a side extension that is sized to overlap a portion of the front skirt and at least a portion of the end wall.

21. The method of claim 13, wherein, in a no-load condition, the front skirt extending substantially parallel to the bottom plate and further comprising the step of folding front skirt when positioning the sill pan in the building opening.

22. The method of claim 13, wherein the rear edge of the bottom plate is raised relative to the front edge.

23. The method of claim 13, further comprising a rear skirt that is connected to the rear edge of the bottom plate and the rear edge of the end wall.

24. A method of installing a sheet of waterproof material on a surface, the surface comprising first, second, and third faces, the first, second, and third faces being non-parallel and intersecting at edges, the edges intersecting at a vertex, the method comprising the steps of:
providing the sheet of waterproof material in a rest position, the sheet of waterproof material being foldable and comprising:
a planar web having a first inner edge, and a second inner edge facing the first inner edge, the first inner edge and the second inner edge meeting at a vertex within the planar web; and
a connecting web connected between the first inner edge and the second inner edge, wherein the connecting web has a surface area that is greater than an area between the first inner edge and the second inner edge; and
conforming the planar web and the connecting web to cover the first, second, and third faces of the surface.

25. The method of claim 24, wherein the planar web comprises a first frame portion and a second frame portion, the first frame portion meeting the second frame portion at a fold line.

26. The method of claim 24, wherein the sheet of material is vacuum-formed.

27. Window flashing, comprising:
a sheet of material that is foldable and substantially inelastic, the sheet of material comprising:
a frame section having a first frame portion and a second frame portion, the first frame portion meeting the second frame portion at a first fold line;
a skirt section meeting the frame section at a second fold line that is perpendicular to the first fold line;
a first inner edge and a second inner edge that extend from a vertex of the first fold line and the second fold line to an outer perimeter of the sheet of material, at least the first inner edge being adjacent to the skirt section; and
a connecting web connected between the first inner edge and the second inner edge;
wherein, in a rest position, the frame section and the first and section portions of the skirt section define a plane, and the connecting web extends outward from the plane; and
wherein, in a use position, the sheet of material is folded along the first fold line and the second fold line to conform to a corner of a window such that the first frame portion is angled relative to the second frame portion and such that the skirt portion and the connecting web extend away from the frame section, the connecting web maintaining an uninterrupted surface between the first and second inner edges as the sheet of material is folded.

28. A method of installing window flashing in a window opening of a wall, the method comprising the steps of:
providing window flashing in a rest position, the window flashing comprising:
a sheet of material that is foldable and substantially inelastic, the sheet of material comprising:
a frame section having a first frame portion and a second frame portion, the first frame portion meeting the second frame portion at a first fold line;
a skirt section meeting the frame section at a second fold line that is perpendicular to the first fold line, the skirt section having a first skirt portion having a first inner edge, and a second skirt portion having a second inner edge facing the first inner edge, the first inner edge and the second inner edge meeting at a vertex of the first fold line and the second fold line; and
a connecting web connected between the first inner edge and the second inner edge;
wherein the frame section and the first and section portions of the skirt section define a plane, and the connecting web extends outward from the plane, the skirt section having a first skirt portion having a first inner edge, and a second skirt portion having a second inner edge facing the first inner edge, the first inner edge and the second inner edge meeting at a vertex of the first fold line and the second fold line;
folding the sheet of material along the first fold line and the second fold line to conform to a corner of the window opening such that the first frame portion is angled relative to the second frame portion and the skirt portion extends away from the frame section, the connecting web maintaining an uninterrupted surface between the first and second inner edges as the sheet of material is folded; and
placing the window flashing into the window opening such that the frame portion overlies at least a portion of an inner surface of the frame, and such that the skirt portion and the connecting web overlies at least a portion of a front face of the frame.
